(19) United States
(12) Patent Application Publication
(10) Pub. No.: US 2012/0215828 A1
(43) Pub. Date: Aug. 23, 2012

(54) INFORMATION PROCESSING SYSTEM, INFORMATION PROCESSING DEVICE, AND RECORDING MEDIUM

(75) Inventors: Osamu TORII, Kanagawa (JP); Takahiko Hayashi, Tokyo (JP); Reiji Yukumoto, Kanagawa (JP); Ayako Watanabe, Kanagawa (JP); Ryo Takemoto, Kanagawa (JP); Masafumi Nagao, Kanagawa (JP); Yasukiyo Nakamura, Kanagawa (JP)

(73) Assignee: RICOH COMAPNY, LTD., Tokyo (JP)

(21) Appl. No.: 13/401,931

(22) Filed: Feb. 22, 2012

(30) Foreign Application Priority Data
Feb. 23, 2011 (JP) 2011-037584

(51) Int. Cl. G06F 15/16

(52) U.S. Cl. 709/202

(57) ABSTRACT

An information processing device is arranged to include a macro changing unit to change a pertinent device of a process in macro information to a second information processing device when the second information processing device has a function required to execute the process and determined as being not executable on the information processing device, and to set the pertinent device in the macro information to the information processing device when the function required to execute the process is determined as being executable on the information processing device.

### BACKGROUND OF THE INVENTION

1. Field of the Invention

The present disclosure relates to an information processing system in which information processing devices are capable of performing device association therebetween using macro information (process execution information).

2. Description of the Related Art

In many cases, when a user executes an application program to perform a desired job on an information processing device, it may be necessary to perform some routine processes prior to an end of the desired task. To reduce the amount of input operations and the number of operational errors, a macro function is often set in the application program by describing a routine process (which is frequently used by the user) in a predetermined format of macro information and registering the macro information in a storage unit of the device.

In an information processing device, such as an office automation device, in which the hardware units thereof operate to perform various functions, operation processes for each function and setting parameters necessary (or selectable) for the operation processes are defined as the macro information. In this case, if the user calls the macro information to operate the office automation device, the desired task can be performed on the office automation device without inputting the setting values corresponding to the functions.

According to a known method, a macro function is extended to enable macro information registered in a certain device to be used by another device. By using the known method, when a user operates a second device other than a first device in which the macro information is registered, the operation to register the macro information in the second device again becomes unnecessary. Only if the macro information is registered in the first device, the desired task can be performed.

However, if multi-function devices having various kinds of functions are taken into consideration, the functions installed in the devices may differ for the individual devices. For this reason, when a user registers the macro information, already registered in a first device, into a second device, a problem may arise. Namely, in such a case, a function used in the macro information in the first device is not included in the functions installed in the second device (the newly macro installed device).

In the above case, even if the second device (the newly macro installed device) checks if the second device has the function set in the macro information, and sets the macro information in an invalid state when the second device does not have the function, the user's operation of registering the modified macro information into the second device (the newly macro installed device) again will be required.

To eliminate the problem, there has been proposed an image processing device adapted for utilizing macro information effectively in a second device (a newly macro installed device) as well. For example, see Japanese Laid-Open Patent Publication No. 2010-026655.

In the image processing device disclosed in Japanese Laid-Open Patent Publication No. 2010-026655, if it is determined that the second device (the newly macro installed device) does not have a function set in the macro information, the second device changes the macro information by deleting the definition and setting value of the function concerned in the macro information, and registers the changed macro information therein.

However, the image processing device disclosed in Japanese Laid-Open Patent Publication No. 2010-026655 has a problem in that the user does not necessarily performs a desired task as the processing result of the macro function. Even if the image processing device can perform a process according to the macro information, the information about the function concerned in the macro information is deleted and the setting value of the function is changed.

For example, when macro information registered in a first device having a color copy function is registered in a second device having no color copy function, the image processing device of Japanese Laid-Open Patent Publication No. 2010-026655 is arranged to change the color copy function described in the macro information to a monochrome copy function that can be used by the newly macro installed device. In this case, if a printed matter by a color copy function is desired by a user, the user cannot obtain the desired matter on the image processing device using the macro function.

For example, when macro information registered in a first device having a facsimile transmission function is registered into a second device having no facsimile function, the image processing device of Japanese Laid-Open Patent Publication No. 2010-026655 cannot perform the function of facsimile transmission based on the registered macro information even if the macro information is changed.

If the function in the macro information which is deleted or changed by the image processing device according to the related art is an important function, it is impossible for the newly macro installed device to obtain a processing result of the function originally set in the macro information.

### SUMMARY OF THE INVENTION

In one aspect, the present disclosure provides an information processing system which is capable of obtaining a processing result desired by a user even when a newly macro installed device does not have a function set in macro information.

In an embodiment which solves or reduces one or more of the above-described problems, the present disclosure provides an information processing system including information processing devices connected via a network, each information processing device including a processor to control the information processing device, the processor including: a macro information reading unit configured to read, from a macro information storage unit or a removable recording medium, macro information in which a pertinent device to perform each process of a series of processes is registered as being the information processing device or another information processing device connected via the network; a device functional composition storage unit which stores device functional composition information of the information processing device; a functional composition check unit configured to determine permission of the information processing device to execute each process, depending on whether a function included in the macro information and required to execute the process is registered in the device functional composition information; a searching unit configured to search a second information processing device connected via the network; an inquiring unit configured to receive an inquiry result response from the second information processing device, indicating whether the second information processing device has a function required to execute the process which function is determined as being not executable on the information processing device by the functional composition check unit; and a macro changing unit configured to change the pertinent device of the process in the macro information to the second information processing device when the second information processing device has the function required to execute the process and determined as being not executable on the information processing device, and set the pertinent device of the process in the macro information to the information processing device when the function required to execute the process is determined as being executable on the information processing device.

Other objects, features and advantages of the present disclosure will become more apparent from the following detailed description when read in conjunction with the accompanying drawings.

### BRIEF DESCRIPTION OF THE DRAWINGS

FIG. 1 is a diagram for explaining an information processing system including a plurality of image forming devices (MFPs).

FIG. 2 is a diagram for explaining an information processing system including a plurality of image forming devices (MFPs).

FIG. 3 is a diagram showing the hardware composition of MFPs in an information processing system of an embodiment of the present disclosure.

FIG. 4A is a block diagram showing the functional composition of an MFP2, and FIG. 4B is a block diagram showing the functional composition of an MFP3.

FIG. 5 is a diagram showing an example of a data structure of macro information.

FIG. 6 is a diagram showing an example of device functional composition information.

FIG. 7 is a diagram showing an example of a checking result output by a functional composition check unit.

FIG. 8 is a diagram showing an example of inquiry information.

FIG. 9 is a diagram showing an example of inquiry result information.

FIG. 10 is a flow diagram for explaining a process performed by a macro import device and an associate candidate device.

FIG. 11 is a diagram for explaining the checking as to whether each function of macro information is executable on the macro import device by itself.

FIG. 12 is a diagram for explaining the checking of functional composition performed by a functional composition check unit.

FIG. 13 is a sequence diagram for explaining how to import macro information.

FIG. 14 is a flow diagram for explaining a process performed by a macro import device and an associate candidate device in an information processing system of an embodiment of the present disclosure.

FIG. 15A and FIG. 15B are diagrams for explaining the checking in the process of FIG. 14.

FIG. 16 is a flow diagram for explaining a process performed by a macro import device and an associate candidate device in an information processing system of an embodiment of the present disclosure.

FIG. 17 is a block diagram showing the functional composition of an MFP of an embodiment of the present disclosure.

FIG. 18A and FIG. 18B are diagrams showing examples of macro information before change.

FIG. 19A and FIG. 19B are diagrams showing examples of inquiry result information received from an MFP3 and an MFP4 respectively.

FIG. 20 is a sequence diagram for explaining how to import macro information.

FIG. 21 is a block diagram showing the functional composition of an MFP of an embodiment of the present disclosure.

FIG. 22A and FIG. 22B are diagrams for explaining changing of macro information.

FIG. 23 is a flow diagram for explaining a process in which an associate device is determined by a macro restoring unit at a time of execution of a function set in macro information.

FIG. 24 is a block diagram showing the functional composition of an MFP of an embodiment of the present disclosure.

FIG. 25 is a flow diagram for explaining a process in which an associate device is determined by a macro restoring unit at a time of execution of a function set in the macro information.

FIG. 26A and FIG. 26B are diagrams showing examples of selection screens displayed on an operation panel.

FIG. 27 is a block diagram showing the functional composition of an MFP of an embodiment of the present disclosure.

FIG. 28 is a flowchart for explaining in which the MFP registers macro information therein by itself.

FIG. 29A and FIG. 29B are diagrams showing examples of selection screens displayed on an operation panel.

FIG. 30 is a block diagram showing the functional composition of an MFP of an embodiment of the present disclosure.

FIG. 31 is a diagram showing an example of a data structure of the number of times of execution of an association job.

FIG. 32 is a diagram showing a device identifier of a macro generating device set in macro information.

FIG. 33 is a flowchart for explaining a process in which an MFP registers macro information therein by itself.

FIG. 34 is a block diagram showing the functional composition of an MFP of an embodiment of the present disclosure.

### DETAILED DESCRIPTION OF THE PREFERRED EMBODIMENTS

A description will be given of embodiments of the present disclosure with reference to the accompanying drawings.

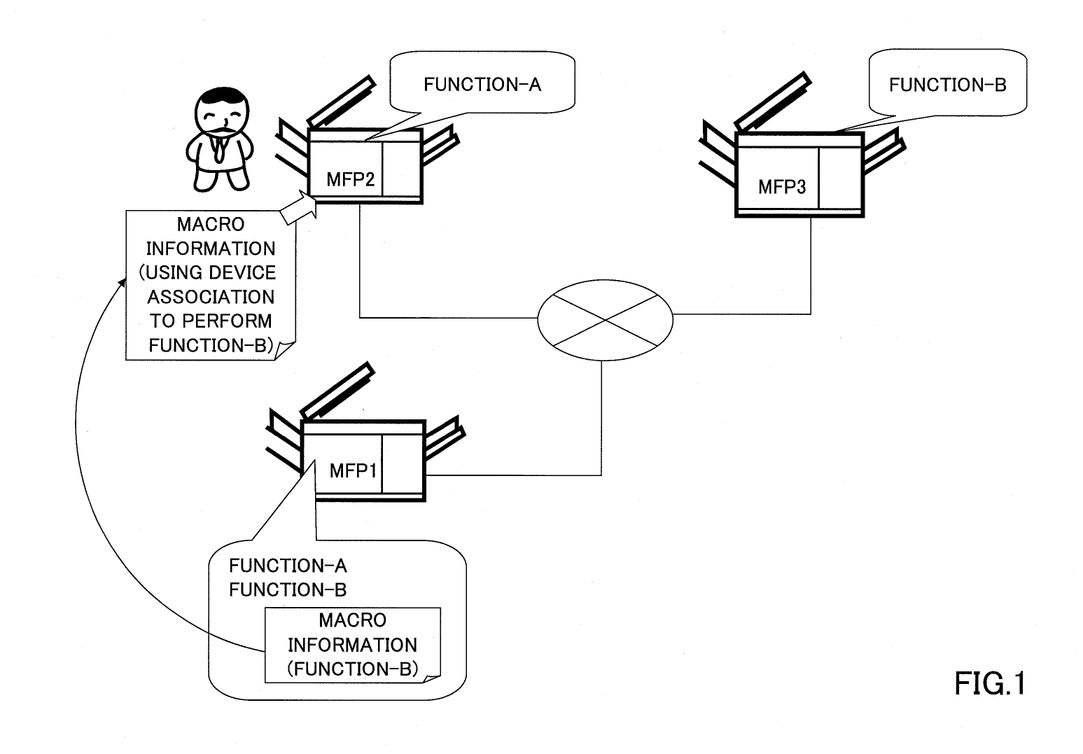

FIG. 1 shows an information processing system including a plurality of image forming devices (MFPs: multi-function peripherals). An MFP (multi-function peripheral) is an information processing device (computer device) that can print, photocopy, fax and/or scan, namely the information processing device having multiple image-forming functions (print, copy, fax and/or scan). As shown in FIG. 1, MFP1, MFP2 and MFP3 are interconnected by a network in the information processing system. The information processing system of FIG. 1 is arranged as follows. MFP1, macro information (registered): function-A, -B MFP2, macro information (newly installed): function-A MFP3, associate device: function-B

In macro information (process execution information) which is initially registered in MFP1 by a user, a process that uses function-B (execution of function-B) is set. The user subsequently registers the macro information in MFP2, and MFP2 does not have function-B.

However, MFP1 and MFP3 other than MFP2 have function-B, and MFP2 can perform function-B by using device association with the other devices.

In this case, MFP2 in the information processing system of FIG. 1 changes the setting value of the macro information to a setting value to perform function-B by using device association, and registers the macro information into MFP2. Even when MFP2 does not have function-B set in the macro information, the user can perform a desired task (a processing result) on MFP2 as a processing result of the macro function through the device association.

The device association with other devices means that the devices interconnected by the network to communicate with each other share functions required for a job (or a set of processes including input and output processes). For example, when two MFPs (or first and second MFPs) carry out facsimile transmission by using the device association, the first MFP having no facsimile transmission function reads image data from a document and transmits the image data to the second MFP having a facsimile transmission function, and the second MFP carries out facsimile transmission of the received image data. In this manner, the first and second MFPs carry out facsimile transmission by using device association.

In the information processing system of FIG. 1, when an association process is contained in macro information, MFP2 may change the association process into a process to be performed by itself (MFP2) at the time of registering the macro information in MFP2 by the user.

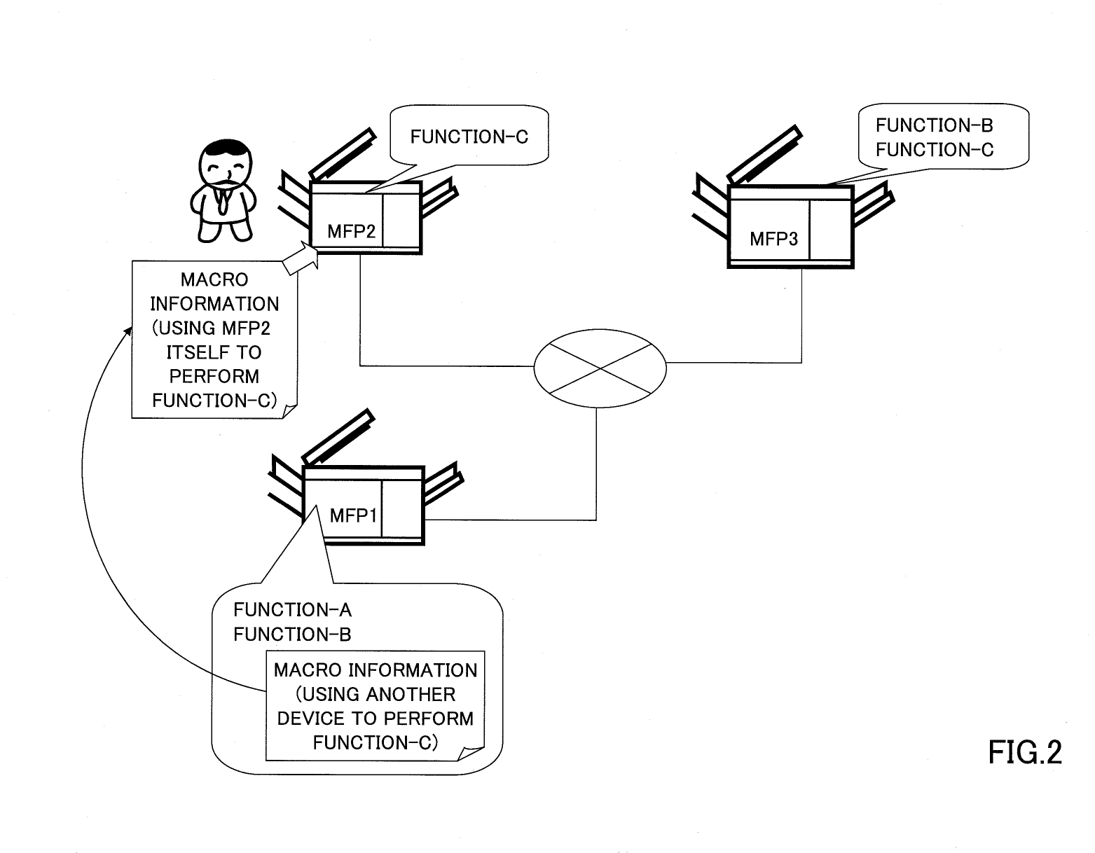

FIG. 2 shows an information processing system including a plurality of image forming devices (MFPs). As shown in FIG. 2, MFP1, MFP2 and MFP3 are interconnected by a network in the information processing system. The information processing system of FIG. 2 is arranged as follows.

MFP1, macro information (function-C to use another device): function-A, -B
MFP2, macro information (newly installed): function-C
MFP3, associate device: function-B, -C

The macro information initially registered in MFP1 is set to perform function-C (which is not installed in MFP1) by using the device association with another device. MFP2 (in which the macro information is subsequently registered by the user) has function-C originally. MFP2 does not need to use the device association with MFP1 when executing function-C set in the macro information. Hence, MFP2 changes a related setting value of the macro information to a setting value that performs function-C on MFP2 by itself, rather than associating with another device, and registers the changed macro information into MFP2. In this manner, MFP2 can perform function C by itself in a shorter time without communicating with another device (MFP1).

As described above, the MFP of the information processing system can change the macro information depending on whether the function set in the macro information can be performed on the MFP by itself. If the user registers macro information in a target MFP, the user can obtain a processing result on the MFP according to the macro information which is changed if needed.

### Embodiment 1

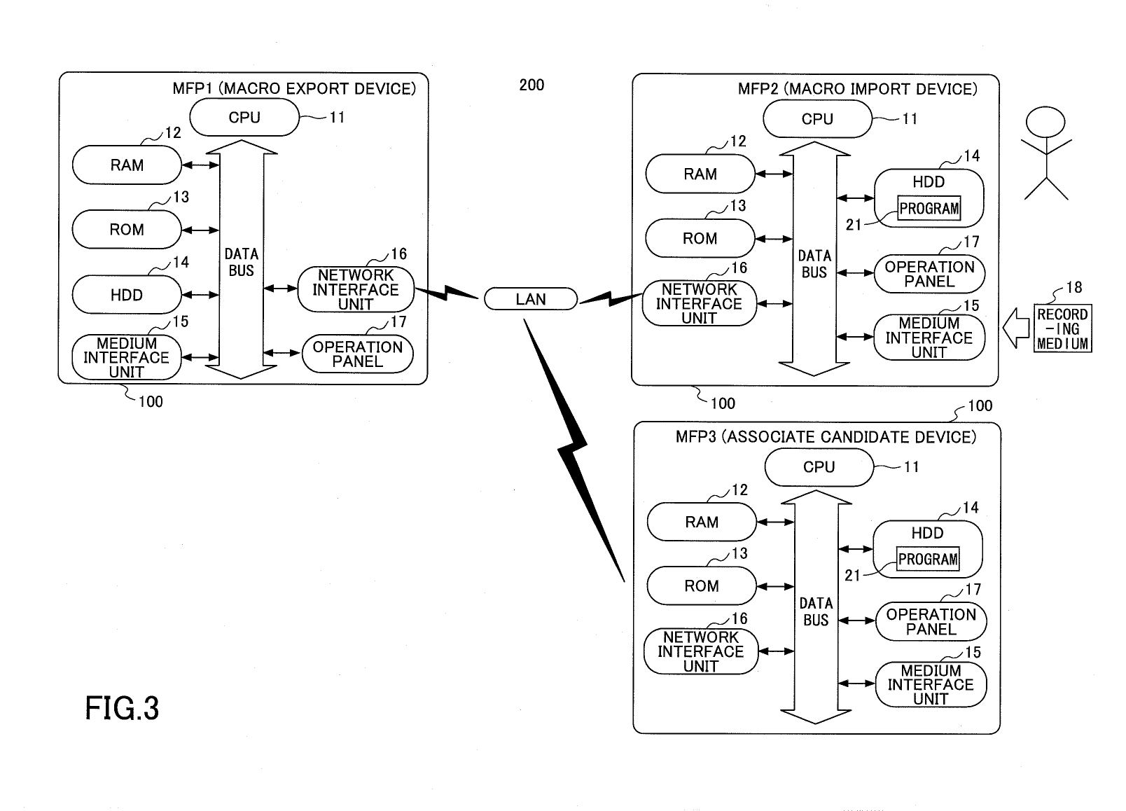

FIG. 3 is a diagram showing the hardware composition of MFPs 100 of an information processing system 200 of an embodiment of the present disclosure. It is supposed that the MFPs 100 in this embodiment include an MFP 100 which exports macro information (this MFP 100 will be called MFP1), an MFP 100 which imports macro information of another device (MFP1) (the MFP 100 will be called MFP2), and an MFP 100 which is an associate device or an associate candidate device for MFP1 or MFP2 (the MFP 100 will be called MFP3).

In this embodiment, each MFP is illustrated as a typical example of an information processing device of the present disclosure in which an application program is executed. However, the information processing device of the present disclosure is not limited to an MFP but may be a personal computer or the like. In order to allow MFP2 to register the macro information registered in MFP1, it is preferred that these MFPs are of the same kind of information processing device. However, information processing devices of different kinds, such as an MFP and a personal computer, may be provided to use the device association.

Each of MFP1, MFP2 and MFP3 is constructed to include a CPU 11, an RAM 12, an ROM 13, a HDD 14, a network interface unit 16, an operation panel 17, and a medium interface unit 15.

The CPU 11 executes a program 21 stored in the RAM 12 and performs control of the parts of the entire MFP and computation and processing of data. The RAM 12 is a work memory which stores temporarily the program 21 executed by the CPU 11 and relevant data. In the ROM 13, various kinds of setting values, such as initial setting parameters of the MFP, are stored. In the HDD 14, the program 21 to control the entire MFP, application programs to perform the functions installed in each MFP 100, etc. are stored with associated data.

The network interface unit 16 is a communication device which communicates with an external device via a network, constructed by wired or wireless data transmission lines, such as LAN (local area network), WAN (wide area network) or the Internet.

The operation panel 17 includes a set of key switches (including hard keys and software keys of GUI (graphical user interface)) and an LCD (liquid crystal display) provided with a touch-panel function. The operation panel 17 provides an UI (user interface) when a user performs a function installed in each MFP 100.

The medium interface unit 15 is an interface to which an external recording medium, such as a USB memory, is attached. This recording medium is a removable non-volatile memory which is detachably attached to the MFP. The recording medium in which various kinds of programs are stored is attached to the medium interface unit 15, and a user may install the program 21 in the HDD 14 through the medium interface unit 15. The program 21 may also be distributed to the MFP via the network interface unit 16.

It is not necessary that MFP1 (macro export device) is connected to MFP3 (associate device or associate candidate device) via the network. However, in this embodiment, there may be a case (the case of FIG. 2) in which the macro information received from MFP1 uses the device association with MFP2 or MFP3. Hence, it is supposed that MFP1 is connected to MFP2 or MFP3 via the network in FIG. 3. There may be a case in which MFP3 (associate candidate device) does not require the operation panel 17. However, for the sake of convenience of description, the case in which MFP3 includes the operation panel 17 is illustrated.

Although it is not illustrated in FIG. 3, each of MFP1, MFP2 and MFP3 includes a printing unit (plotter) and a document reading unit (scanner). The printing unit outputs image data to a copy sheet (print sheet) by printing according to an electrophotographic printing process (exposure, latent image formation, development, and image transfer) using a laser beam, or an ink-jet printing process which discharges droplets of ink. The document reading unit includes a line sensor composed of photoelectric transducers, such as CCD (charge coupled devices) or CMOS, an A/D converter, and a drive circuit to drive these elements. The document reading unit generates digital image data of RGB each having 8 bits by scanning a document placed on a document reading base (on a contact glass).

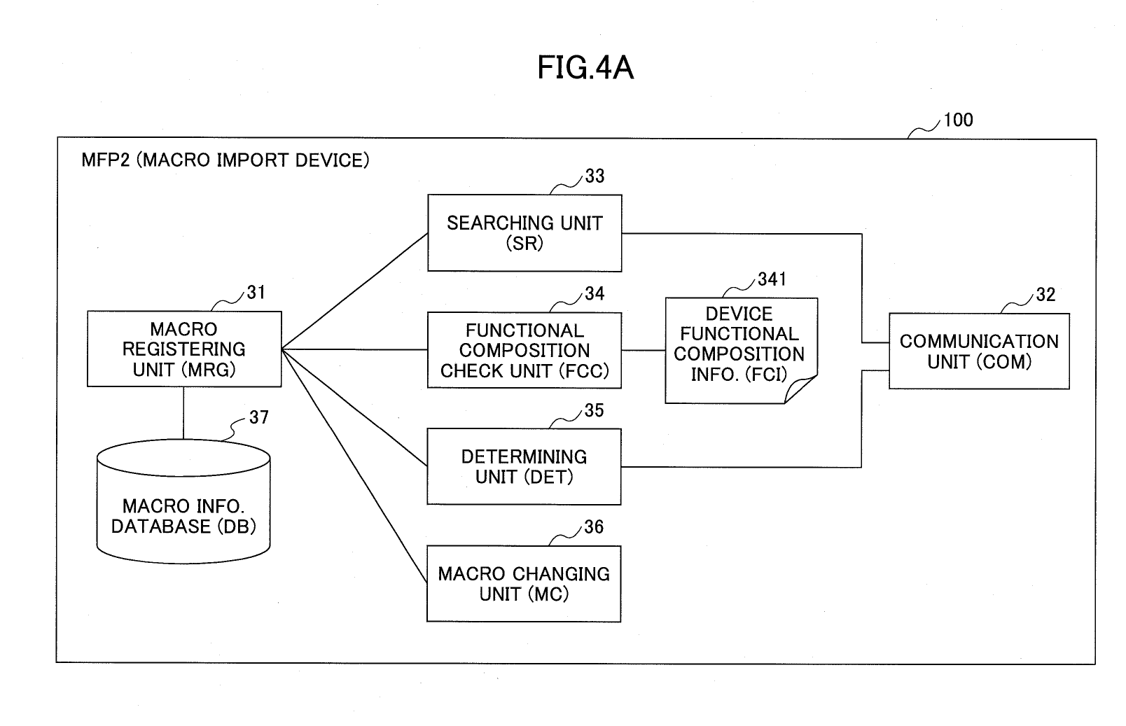

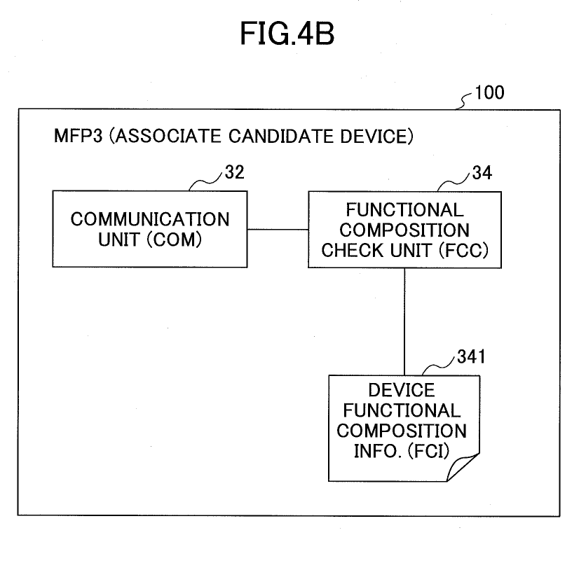

FIG. 4A is a block diagram showing the functional composition of MFP2 and FIG. 4B is a block diagram showing the functional composition of MFP3. The functional composition of each MFP may be realized by a hardware circuit, such as LSI, or by the CPU 11 executing the program 21 read from the HDD 14.

Although it is not illustrated in FIG. 4B, MFP3 may have the functional composition that is the same as that of MFP2 as illustrated in FIG. 4A. Although it is not illustrated in FIG. 4A and FIG. 4B, MFP1 may have the functional composition that is the same as that of MFP2 as illustrated in FIG. 4A.

As shown in FIG. 4A, a macro registering unit (MRG) 31 stores macro information into a permanent storage area, or a macro information database (DB) 37. The macro information database (DB) 37 is mounted in the HDD 14 in many cases. Otherwise, the macro information database (DB) 37 may be a storage medium which is readable by MFP2. The macro information is restored by the macro restoring unit described later, and the macro information is converted into macro data in an executable format so that the macro is performed by an application program.

In the following, execution of a function set in the macro information and execution of a series of processes set in the macro information will be referred to as “execution of a macro” or “performing a macro”. When the execution of a macro requires the device association, the MFP 100 in which the macro information is registered becomes the subject of execution of the macro. Even when the subject of execution of a macro is MFP2, there is a case in which the subject of execution of a function becomes MFP1 or MFP3.

As shown in FIG. 4A and FIG. 4B, a communication unit (COM) 32 transmits or receives various items of information to or from another MFP via the network. For example, the communication unit (COM) 32 of MFP2 communicates with MFP3, and the communication unit (COM) 32 of MFP3 communicates with MFP1.

As shown in FIG. 4A, a searching unit (SR) 33 uses its host device (MFP2) and searches the associate candidate devices (=MFP1 and MFP3) through the network.

A shown in FIG. 4A and FIG. 4B, a functional composition check unit (FCC) 34 determines whether a function and setting value set in the macro information are executable on MFP2 by itself.

As shown in FIG. 4A, a determining unit (DET) 35 determines which device (MFP2 or one of associate candidate devices) is to perform each of the functions required in the series of processes included in the macro information.

As shown in FIG. 4A, a macro changing unit (MC) 36 changes the setting value of the macro information.

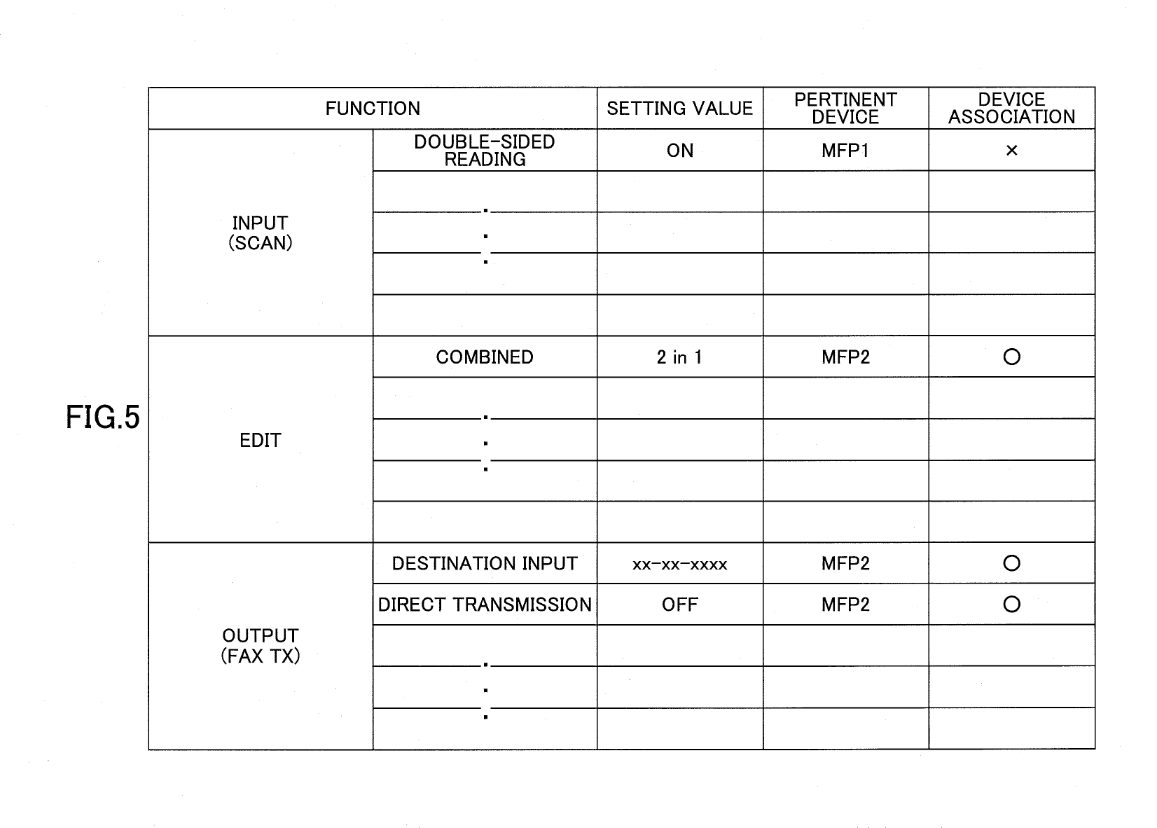

FIG. 5 is a diagram showing an example of a data structure of macro information. As shown in FIG. 5, the macro information is registered to include, for each “function”, a “setting value”, a “pertinent device” (which identifies a device to perform the function or macro), and an “association” (which indicates whether the device association is possible).

Each “function” is a function required to perform a series of processes included in a job requested by a user. By classifying the “functions” into three categories: input, edit (processing) and output, it is possible to provide versatility and ease of handling.

For example, the input functions may include a document reading function (creation of image data) by a document reading unit (not illustrated), a function of reading document data which is transmitted from a personal computer or the like via the network and stored in the HDD 14, a function of reading document data from a USB memory, and a function of setting image data received by facsimile to input data.

The edit functions may include various kinds of image transforming functions (for example, “combined”, “expansion” or “reduction”) of transforming input image data, and a function (rendering) of converting input PostScript data into bit map data and outputting the bit map data.

The output functions may include a function of outputting (printing) the processed data to a printing unit (not illustrated), a function of storing the processed data in the HDD 14, a function of transmitting the processed data by e-mail, a function of transmitting the processed data by facsimile, a function of transmitting the processed data to a personal computer, or a function of displaying a preview image of the processed data on the operation panel 17.

For example, regarding the function of “double-sided reading” as illustrated in FIG. 5, the “association” item is set to “x”, indicating that the “double-sided reading function” is provided in MFP1 in which the macro information is registered. Regarding the functions of “combined”, “destination input” and “direct transmission”, the “association” items are set to “O”, indicating that these “functions” are not installed in MFP1 in which the macro information is registered.

The “setting value” indicates a specific value (parameter value) which is set up because the value is required to perform the input, edit and output “functions” or is selectable. For example, the “setting value” for the “double-sided reading” function is set to “ON” or “OFF”. In the example of FIG. 5, the “setting value” for the “double-sided reading” function is set to “ON”, indicating that the “double-sided reading” function is to be used when the requested job is performed. The “setting value” for the “combined” function is set to one of “2_in_{—}1”, “4_in_{—}1” and “8_in_{—}1” options. In the example of FIG. 5, the setting value is set to “2_in_{—}1”, indicating that the “2_in_{—}1” option is to be used when the requested job is performed.

The “setting value” for the “destination input” function is set to a “user name/fax number”. In the example of FIG. 5, the setting value is set to a fax number “xx-xx-xxxx”, indicating that the fax number is set up by the user. The “setting value” for the “direct transmission” function is set to “ON” or “OFF”. In the example of FIG. 5, the “setting value” for the “direct transmission” function is set to “OFF”. On the other hand, when the “setting value” for the “direct transmission” function is set to “ON”, the transmission of image data is promptly done after the image data is read by the document reading unit.

The “pertinent device” indicates which device takes charge of execution of the “function”. In the example of FIG. 5, the “pertinent device” for the “double-sided reading” function is set to “MFP1”, while the “pertinent device” for each of the “combined”, “destination input” and “direct transmission” functions is set to “MFP2”. This means that MFP1 is to perform the “double-sided reading” function and MFP2 is to perform each of the “combined”, “destination input” and “direct transmission” functions. Therefore, this macro information includes a function processed by the device association.

The “association” indicates whether the “function” is to be processed by the device association from the standpoint of MFP1 in which the macro information is registered. For example, MFP1 performs the double-sided reading function by itself and the “association” item is set to “x”. However, MFP2 may perform the “combined”, “destination input”, and “direct transmission” functions instead of MFP1, and the “association” items for these functions are set to “O”.

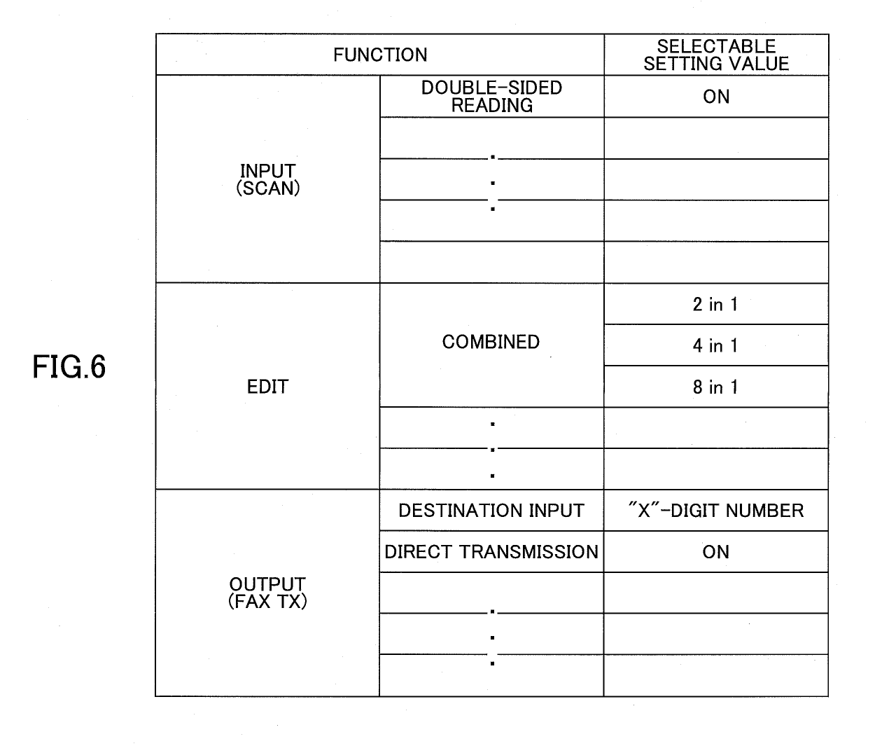

FIG. 6 is a diagram showing an example of device functional composition information (FCI) 341. This device functional composition information (FCI) 341 contains “functions” installed in each MFP and “selectable setting values” which are selectable for the functions of the MFP respectively.

In order to allow MFP2 to distribute the “functions” to MFP2 itself and the other devices MFP1 and MFP3, it is preferred that MFP2 receives the “setting values” of MFP2 itself and the “selectable setting values” selectable for the “functions” of the other devices MFP1 and MFP3. Hence, each of MFP1, MFP2 and MFP3 stores the device functional composition information (FCI) 341 as illustrated in FIG. 6 in the ROM 13 or the HDD 14. As shown in FIG. 6, as for a “function”, such as the “combined” function, two or more setting values are present.

For example, when a user registers the macro information from MFP1 into MFP2, the functional composition check unit (FCC) 34 of MFP2 compares the macro information with the device functional composition information (FCI) 341 of MFP2 and determines whether each function of the macro information is executable on MFP2 by itself.

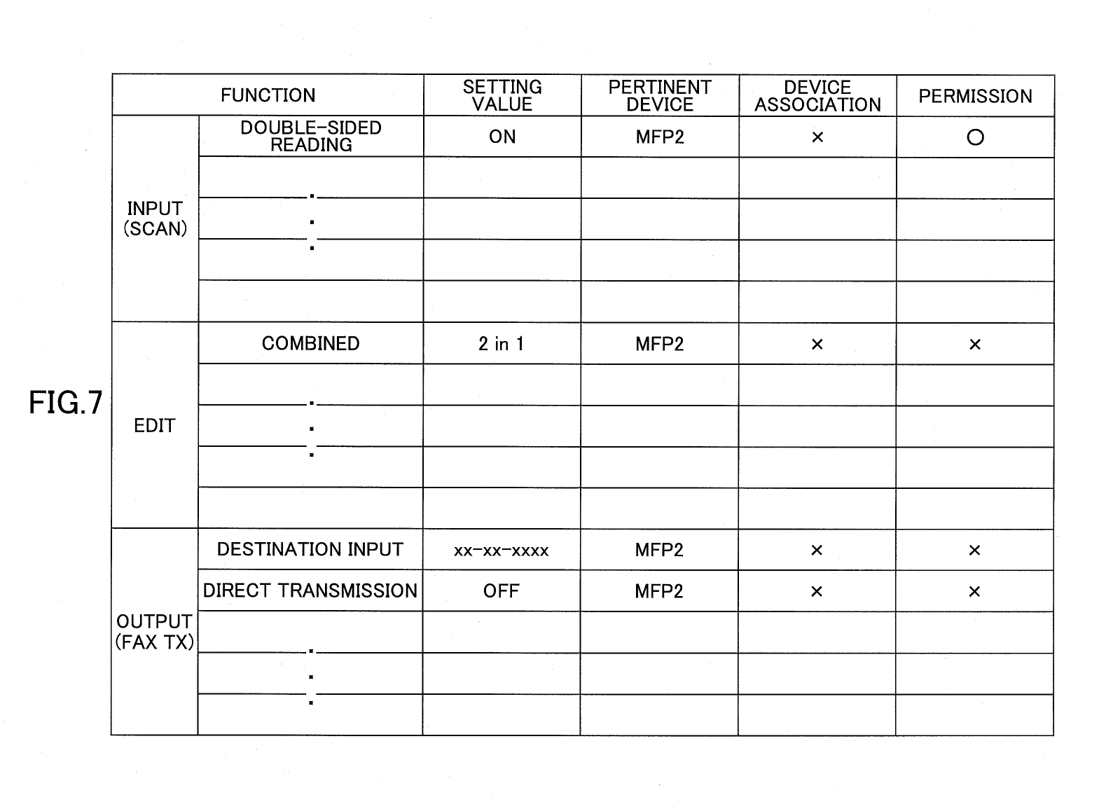

FIG. 7 is a diagram showing an example of a checking result (functional composition checking result information) output by the functional composition check unit (FCC) 34. As shown in FIG. 7, the checking result (functional composition checking result information) has a data structure that is same as that of the macro information and further includes a “permission” in addition to the elements of the macro information.

The “permission” indicates whether each “function” set in the macro information is executable on the MFP2 (macro import device) by itself. Setting the “permission” to “O” indicates that the “function” is executable by itself. Setting the “permission” to “x” indicates that the “function” is not executable by itself.

When the “permission” for a certain function is set to “O”, the macro changing unit (MC) 36 changes the “pertinent device” of the function to the device itself (MFP2). Thereby, the “pertinent device” of the function executable on the MFP by itself can be changed to the MFP itself.

The checking result information indicates that it is determined that the functions “combined”, “destination input” and “direct transmission” are not executable on MFP2 by itself. In this case, the determining unit (DET) 35 needs to check whether the “functions” which cannot be performed by MFP2 can be performed by another MFP. Inquiry information will be sent to the other devices MFP1 and MFP3, in order to receive an inquiry result response indicating whether the “functions” are executable on MFP1 or MFP3.

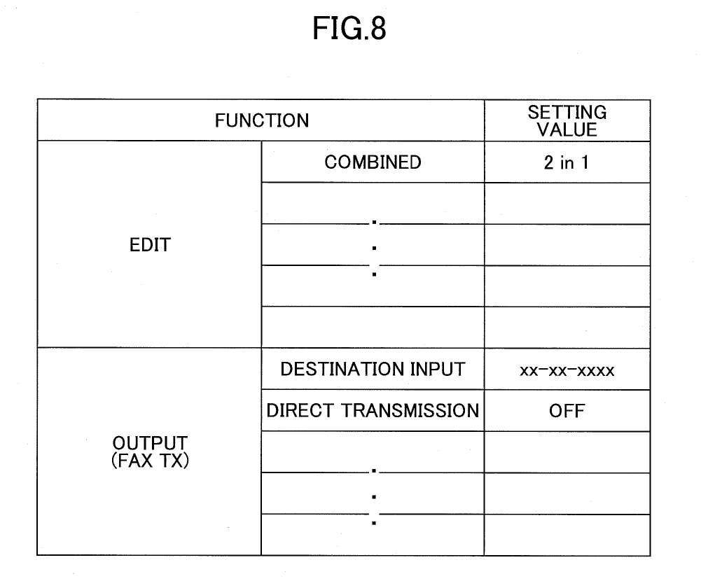

FIG. 8 is a diagram showing an example of inquiry information. The inquiry information is transmitted to the associate candidate device by MFP2 when asking the associate candidate device (MFP1 or MFP3) searched by the searching unit (SR) 33.

The determining unit (DET) 35 of MFP2 (macro import device) transmits inquiry information to the associate candidate in order to ask whether the “function” which cannot be performed on MFP2 by itself can be performed. By transmitting only the non-executable “functions” of MFP2 thereto as shown, the communication time can be shortened. Alternatively, all the data elements of the checking result information from the functional composition check unit (FCC) 34 as in FIG. 7 may be transmitted.

After the inquiry information is received, the functional composition check unit (FCC) 34 of MFP1 or MFP3 (which is the associate candidate device) determines whether each “function” in the received inquiry information is executable on the MFP by itself, and transmits inquiry result information to MFP2 (which has transmitted the inquiry information).

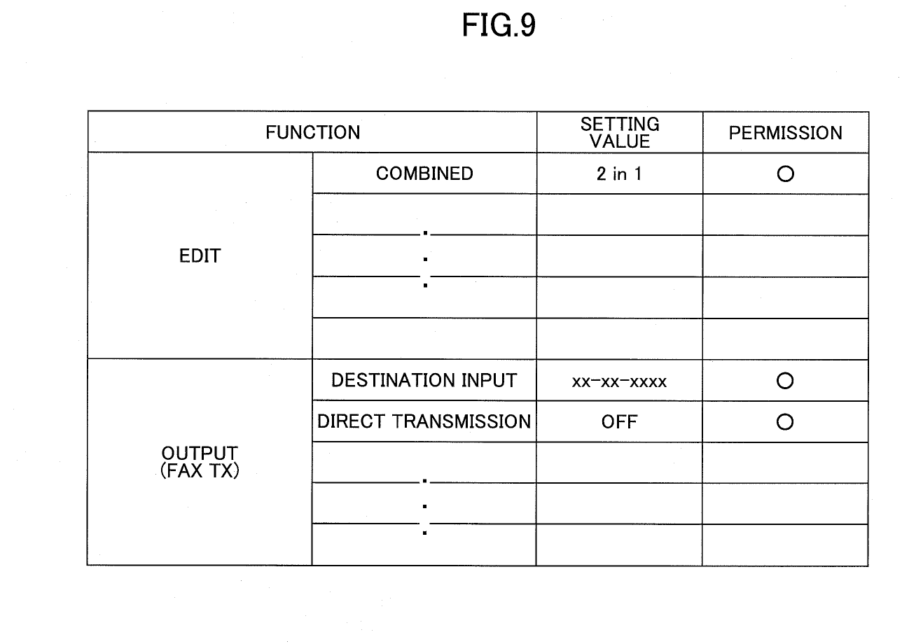

FIG. 9 is a diagram showing an example of inquiry result information. The inquiry result information has a data structure in which “permission” is added to that of the inquiry information. The “permission” indicates for each function whether the function is executable on the associate candidate device. The “permission” is set to “O” when the function is executable thereon, and set to “x” when the function is not executable thereon.

The functional composition check unit (FCC) 34 of MFP1 or MFP3 reads the device functional composition information (FCI) 341 of the device itself, determines whether the device has the “function” in the received inquiry information, and generates inquiry result information. In the example of FIG. 9, the inquiry result information indicates that the “combined” function of “2 in 1”, the “destination input” function and the “direct transmission” are executable on the associate candidate device (MFP1 and/or MFP3).

The MFP2 (macro import device) changes the macro information based on the inquiry result information, and registers the changed macro information in the macro information database (DB) 37.

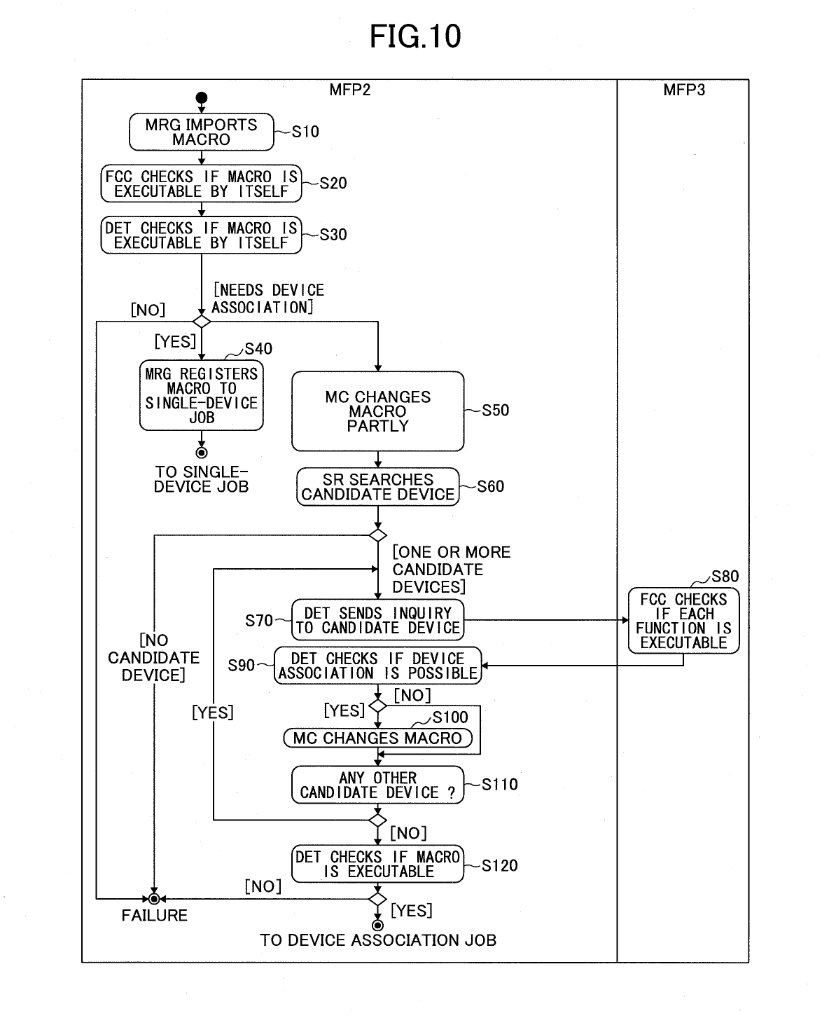

FIG. 10 is a flow diagram for explaining a process performed by a macro import device and an associate candidate device. In FIG. 10, MFP2 is a macro import device, and MFP3 is an associate candidate device. Also, MFP1 (not shown in FIG. 10) is a macro export device.

First, the macro registering unit (MRG) 31 reads the macro information registered in MFP1 from the macro information database (DB) 37 of MFP1 or the recording medium 18, and starts the macro registration process (S10).

A trigger of hitting the start button may be an input operation by which a user operates the operation panel 17 of MFP2 to call the macro information of MFP1, or an input operation by which a user operates the operation panel 17 of MFP2 to register the macro information of MFP1 into MFP2 after the macro information of MFP1 is copied to the recording medium 18 and the medium 18 is attached to the medium interface unit 15 of MFP2.

Next, the functional composition check unit (FCC) 34 of MFP2 determines whether each function of the macro information is executable on the MFP by itself (S20). The algorithm of the checking will be described.

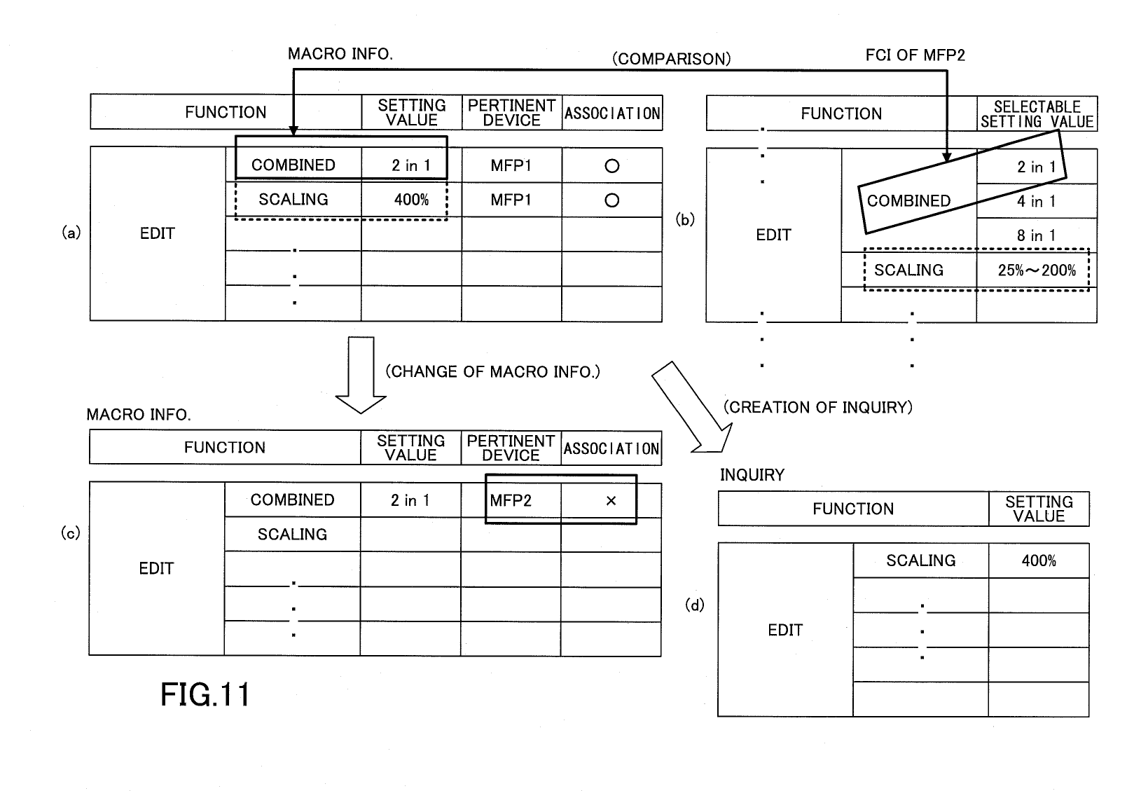

FIG. 11 is a diagram for explaining checking as to whether each function of macro information is executable on the MFP by itself. Specifically, FIG. 11(a) shows an example of macro information and FIG. 11(b) shows an example of device functional composition information respectively.

The functional composition check unit (FCC) 34 of MFP2 determines whether each function can be performed by itself for every function of macro information as compared with the device functional composition information. Specifically, the functional composition check unit (FCC) 34 determines permission depending on whether a combination of “function” and “setting value” included in the macro information is included in a combination of “function” and “selectable setting value” of the device functional composition information of MFP2 (macro import device). If the combination of “function” and “setting value” of the macro information is included in the device functional composition information, it is determined that the function is executable. Otherwise, it is determined that the function is not executable.

As a result of the checking, the macro changing unit (MC) 36 sets the pertinent device of the executable “function” to MFP2 and sets the “association” thereof to “x”.

FIG. 11(c) shows an example of the changed macro information. When compared with FIG. 11(a), in FIG. 11(c), the “pertinent device” of the “combined” function is changed from MFP1 to MFP2 and the “association” thereof is changed from “O” to “x”, respectively.

Referring back to FIG. 10, the determining unit (DET) 35 determines whether a “function” set in the macro information is executable on the MFP by itself (S30). In the macro registering unit (MRG) 31, the determining unit (DET) 35 will register macro information into itself as it is, if all the “functions” are determined as being executable on the MFP by itself (S40).

If the determining unit (DET) 35 determines that all the “functions” required to perform the series of processes cannot perform on the MFP by itself, it is determined that a failure of macro registration occurs. Even in this case, if the device association is used, MFP2 may be able to perform the macro. However, the “functions” required to perform the input, edit and output processes are not executable on the macro import device (=MFP2) by itself, and it is determined in this embodiment that a macro registration failure occurs.

When the determining unit (DET) 35 determines that the “functions” are partly executable on the MFP by itself (which needs the device association with the other device MFP1 and MFP3), the macro changing unit (MC) 36 changes the macro information only for the “functions” executable on the MFP by itself (S50) as shown in FIG. 11(c).

Subsequently, in order to search for the associate candidate device which can perform the non-executable “function” of MFP2, the searching unit (SR) 33 searches the associate candidate device (S60).

The searching unit (SR) 33 starts communicating with all the MFPs connected via the network, and this search is performed by receiving a response from the associate candidate device. Alternatively, a list of the associate candidate devices may be stored beforehand and the searching unit (SR) 33 may communicate with each associate candidate device in the list.

The determining unit (DET) 35 collects the non-executable “functions” of the MFP, generates inquiry information, and transmits the inquiry information to each associate candidate device in order to determine the associate device to perform the non-executable “functions” (S70).

FIG. 11(d) shows an example of inquiry information. According to the device functional composition information of FIG. 11(b), the “selectable setting value” of “scaling” of MFP2 is set to “25%-200%” while the “scaling” of the macro information is “400%”. In this case, the functional composition check unit (FCC) 34 determines that the “400%” scaling function is not executable on MFP2, and transmits inquiry information in which the “function” is set to “scaling” with the “setting value” being set to “400%”, to the associate candidate device.

The associate candidate device receives the inquiry information, and the functional composition check unit (FCC) 34 of the associate candidate device determines whether the function with the “setting value” in the inquiry information is executable on the device by itself (S80).

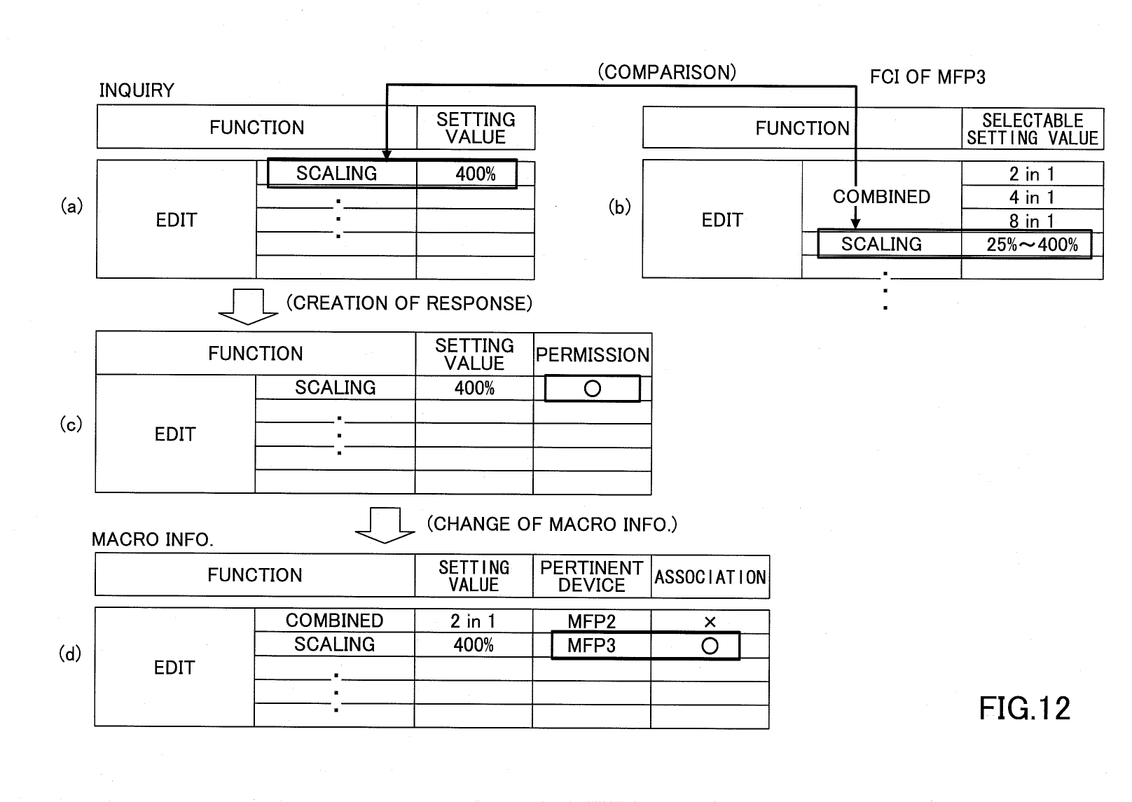

FIG. 12 is a diagram for explaining the checking by the functional composition check unit (FCC) 34. Specifically, FIG. 12(a) shows an example of inquiry information and FIG. 12(b) shows an example of device functional composition information, respectively.

The functional composition check unit (FCC) 34 of the associate candidate device compares the inquiry information received from MFP2 with the functional composition information of the associate candidate device, and determines whether each function is executable on the associate candidate device.

As described above, the permission of the associate candidate device is determined depending on whether a combination of the “function” and the “setting value” described in the inquiry information is contained in a combination of “function” and “selectable setting value” of the functional composition information of the associate candidate device.

In the above example, the “function” of the inquiry information is “scaling” and its “setting value” is “400%”, while a “scaling” function is contained in the “functions” of the device functional composition information, and its selectable setting value thereof is “25 to 400%”. For this reason, the functional composition check unit (FCC) 34 of the associate candidate device determines that the function is executable thereon, and transmits the inquiry result information (to which the permission information is added) to MFP2 (macro import device).

FIG. 12(c) shows an example of the inquiry result information. The “permission” item in the inquiry result information is set to “O”, which indicates that the function is permitted to execute on the associate candidate device.

Referring back to FIG. 10, the determining unit (DET) 35 of MFP2 determines whether the “function” (which is not executable on MFP2) is executable on MFP1 or MFP3, based on the inquiry result information (S90). Having received the inquiry result information, the determining unit (DET) 35 of MFP2 determines that the “function” corresponding to the “permission” being set to “O” is executable on the associate candidate device. The macro changing unit (MC) 36 rewrites the “pertinent device” of the “function” corresponding to the “permission” being set to “O”, by identification information of the associate candidate device (S100). If the associate candidate device is MFP3, the “pertinent device” in the macro information is set to MFP3. In this manner, the macro information is changed.

FIG. 12(d) shows an example of the macro information after change. In FIG. 11(d), the “pertinent device” for the “combined” function is changed to MFP2. Further, in FIG. 12(d), “the pertinent device” for the “scaling” function is changed to MFP3. The pertinent device which performs the process to execute the “400%” scaling function is set to MFP3, and the “association” for the “scaling” function is set to “O”.

The determining unit (DET) 35 repeats the inquiry and checking to determine whether each function is executable until all the “pertinent devices” of all the “functions” included in the macro information are determined. The determining unit (DET) 35 determines whether all the “pertinent devices” for all the “functions” included in the inquiry information are determined (S110).

After the inquiry result responses are received from all the associate candidate devices, the determining unit (DET) 35 determines that all the associate candidate device are asked. The determining unit (DET) 35 determines whether some of the “functions” included in the inquiry information whose “pertinent devices” are not determined are present (S120).

When some “functions” whose “pertinent devices” are not determined are present, the determining unit (DET) 35 determines that the macro cannot be executed. In this case, it is determined that a failure of macro registration occurs.

When all the “pertinent devices” are determined, the determining unit (DET) 35 determines that the macro can be performed, and registers the macro information in the macro information database (DB) 37.

As described above, the process of FIG. 10 is carried out. If needed, the MFP2 (macro import device) changes the macro information to perform the device association and registers the changed macro information in the macro information database (DB) 37.

As described above, when MFP2 (macro import device) imports the macro information, it is ensured that the imported macro can be performed even when the function in the macro is not executable on MFP2. Even if the macro is performed by another MFP, it is ensured that the processing result obtained by execution of the macro becomes the same.

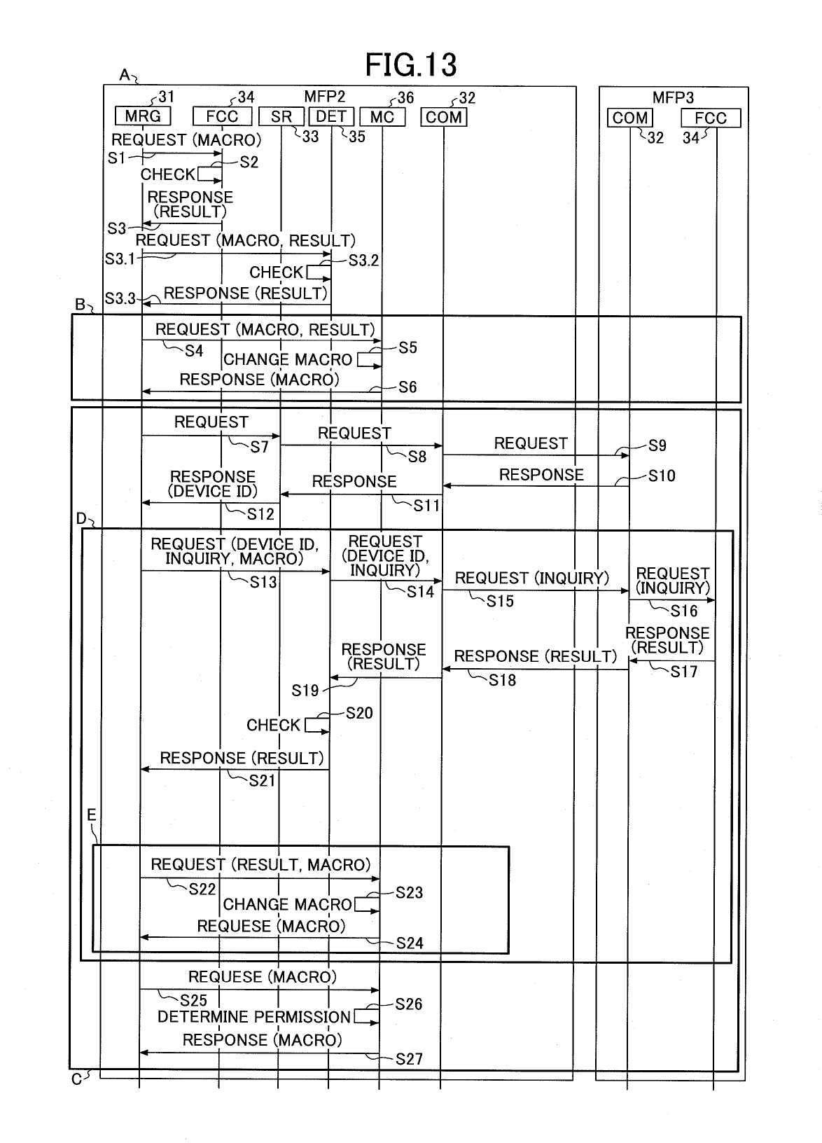

FIG. 13 is a sequence diagram for explaining how to import the macro information. In FIG. 13, MFP2 is a macro import device, and MFP3 is an associate candidate device.

(A) If a user performs an input operation to import macro information to MFP2 (macro import device), the read macro information is a processing object of the macro registering unit (MRG) 31.

S1: in order to check whether the required “function” exists in MFP2 when performing the “function” set in the macro information, the macro registering unit (MRG) 31 transmits the macro information to the functional composition check unit (FCC) 34 and requests the FCC 34 to check the functional composition of MFP2.
S2: the functional composition check unit (FCC) 34 compares the macro information with the device functional composition information of MFP2 (macro import device) itself, and checks whether MFP2 has the required “function” by the macro information.
S3: the functional composition check unit (FCC) 34 transmits the functional composition checking result information as the determined result to the macro registering unit (MRG) 31.
S3.1: the macro registering unit (MRG) 31 causes the determining unit (DET) 35 to transmit the functional composition checking result information and macro information, and requires check whether macro information can be performed by itself, or association is required.
S3.3: the determining unit (DET) 35 compares macro information with functional composition checking result information, and generates check result information whether it is executable on the MFP by itself, for every function.
S3.4: the determining unit (DET) 35 transmits the check result information to the macro registering unit (MRG) 31.

(B) Macro information change processing

S4: when a “function” among “functions” set in the macro information is executable on the macro import device, the macro registering unit (MRG) 31 transmits the check result information and macro information to the macro changing unit (MC) 36.
S5: the macro changing unit (MC) 36 sets identification information of the device itself as the “pertinent device” of executable “function”, and setting “x” as “association”, and changes the macro information. “O” is set as “association” of a “function” of that it cannot perform by itself.
S6: the macro changing unit (MC) 36 transmits the changed macro information to the macro registering unit (MRG) 31, the macro registering unit (MRG) 31 registers changed macro information into macro information database (DB) 37.

(C) Searching of associate candidate device

S7: when the device association with other devices is required to perform the macro, the macro registering unit (MRG) 31 causes the searching unit (SR) 33 to search the associate candidate devices (when the macro is not executable on the MFP2 by itself).
S8: the searching unit (SR) 33 searches the associate candidate devices which can associate with the MFP itself by using the communication unit (COM) 32.
S9-S12: the searching unit (SR) 33 transmits the identification information of the associate candidate device which had a response by search to the macro registering unit (MRG) 31 as a result of search.

(D) The macro information is changed so that the “function” which is not executable on the MFP2 will be executed by the associate candidate device. The macro registering unit (MRG) 31 performs the following steps to all the associate candidate devices that are found as a result of the searching. However, some of the following steps may not necessarily be performed to all the associate candidate devices if the associate device is chosen from among the associate candidate devices.

S13: the macro registering unit (MRG) 31 transmits the identification information of the associate candidate device, the inquiry information, and the macro information to the determining unit (DET) 35.
S14-S15: the determining unit (DET) 35 transmits the inquiry information to the associate candidate device via the communication unit (COM) 32.
S16-S17: the functional composition check unit (FCC) 34 of the candidate associate device which has received the inquiry information, compares the inquiry information with the device functional composition information of the device, generates inquiry result information indicating whether the “function” with the “setting value” in the received inquiry information is executable on the device, and transmits the same to MFP2 via the communication unit (COM) 32.
S18-S19: the determining unit (DET) 35 receives the result information via the communication unit (COM) 32.
S20-S21: the determining unit (DET) 35 determines whether it is necessary to change the “pertinent device” of macro information, and “association” based on the inquiry result information, and sends the check result information which is the check result to the macro registering unit (MRG) 31.
S22: when it is determined that the macro information needing to be changed from the check result information, the macro registering unit (MRG) 31 transmits the check result information and the macro information to the macro changing unit (MC) 36, and requests the changing of the macro information.
S23-S24: the macro changing unit (MC) 36 changes “the pertinent device” into the associate candidate device, and transmits the changed macro information to the macro registering unit (MRG) 31.
S25: the macro registering unit (MRG) 31 transmits the changed macro information to the determining unit (DET) 35, and the determining unit (DET) 35 is requested to determine whether the macro is executable on MFP2, i.e., a check of whether “the pertinent device” is determined about all the “functions”.
S26: the determining unit (DET) 35 determines whether the “function” in the macro information is executable. When the “function” which cannot be performed even if it cooperates among “functions” of macro information is also one, the determining unit (DET) 35 determines that the macro cannot be performed, and otherwise, determines that the macro can be performed.
S27: the determining unit (DET) 35 sends a notice of a macro execution permission check result which is the result of checking to the macro registering unit (MRG) 31. In response to the notice of the macro execution permission check result, the macro registering unit (MRG) 31 deletes macro registration information when the macro is not executable by itself. Namely, if execution is improper, it will prevent that macro information which execution cannot do by deleting macro information registered into the macro information database (DB) 37 is registered.

When the macro is determined as being not executable on MFP2, the macro registering unit (MRG) 31 displays an error message on the operation panel 17 and reports to the user that the macro information cannot be registered. Viewing the error message, the user can take a suitable remedial measure. When the macro is determined as being executable on MFP2, the macro information is registered into the macro information database (DB) 37 without change.

As described above, in this embodiment, even when the newly macro installed device (MFP2) does not have the “function” set in the macro information, the user can obtain a desired processing result by setting the macro information so as to perform the “function” using the device association with the associate device (MFP3) and registering the macro information into the device (MFP2).

### Embodiment 2

When execution of a “function” by device association is already set in the macro information which is imported by the MFP2 (macro import device), there is a case in which changing further the macro information is not needed. For example, it is a case in which the macro information of MFP1 is set up to cause MFP1 to perform a certain “function” thereof using the device association with MFP3. In this case, changing further the macro information of MFP2 is not needed. Even if the imported macro information is further changed, MFP2 can perform the function using the device association with MFP3.

In this embodiment, when a “function” requiring the device association in the macro information after change requires the device association also in the macro information before change, MFP2 uses the macro information without change. Such embodiment will be described. According to this embodiment, MFP2 can find the associate device in a short time and can use the data related to the associate device (e.g., an address book).

Briefly speaking, when a “function” in the macro information after change is determined as requiring the device association at the functional composition check unit (FCC) 34 of MFP2, the determining unit (DET) 35 determines whether the “function” in the macro information before change also requires the device association.

Specifically, the determining unit (DET) 35 of MFP2 at this time compares the macro information before change and the changed macro information (in which the setting value of the device association for each function is changed depending on whether the function requires the device association). Then, the determining unit (DET) 35 of MFP2 determines whether a “function” in the macro information after change which requires the device association also requires the device association in the macro information before change.

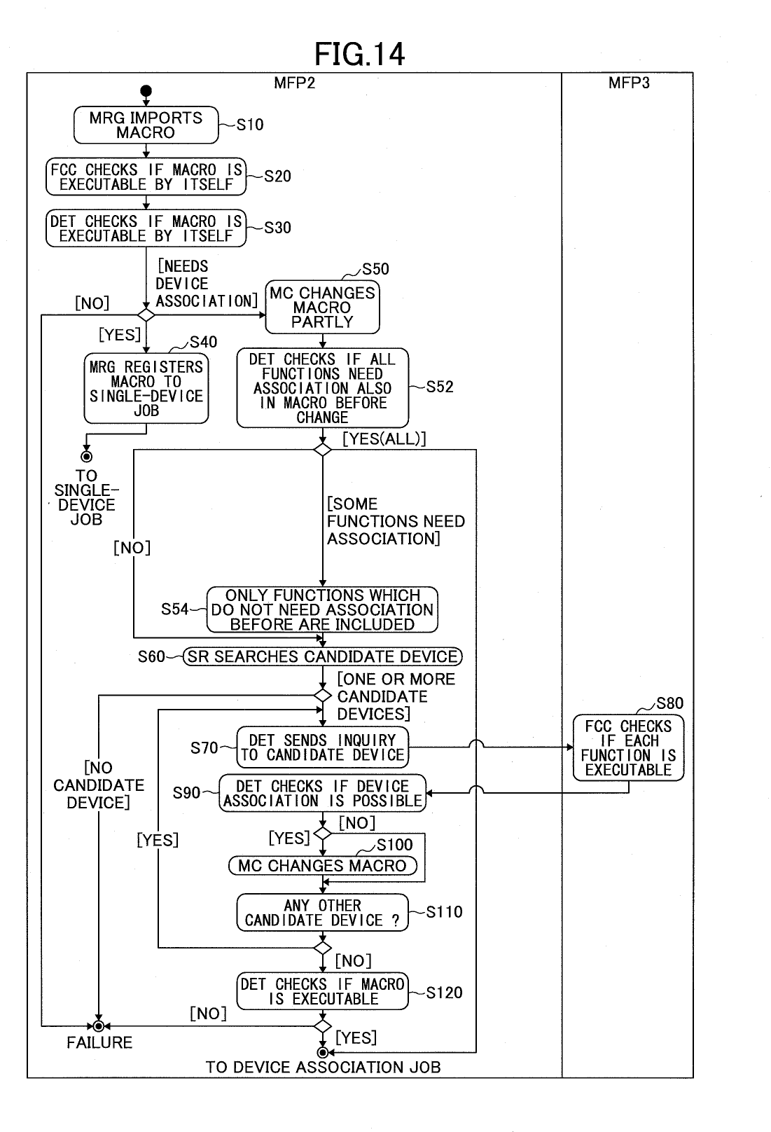

FIG. 14 is a flow diagram for explaining a process performed by a macro import device (MFP2) and an associate candidate device. In FIG. 14 and subsequent figures, MFP2 is a macro import device and MFP3 is an associate candidate device. In FIG. 14, the steps which are the same as corresponding steps in FIG. 10 are designated by the same reference numerals, and a description thereof will be omitted.

In the process of FIG. 14, steps S52 and 54 are additionally included in the steps S50-S60.

S52: the determining unit (DET) 35 checks whether all “functions” requiring the device association in the macro information after change require the device association also in the macro information before change.

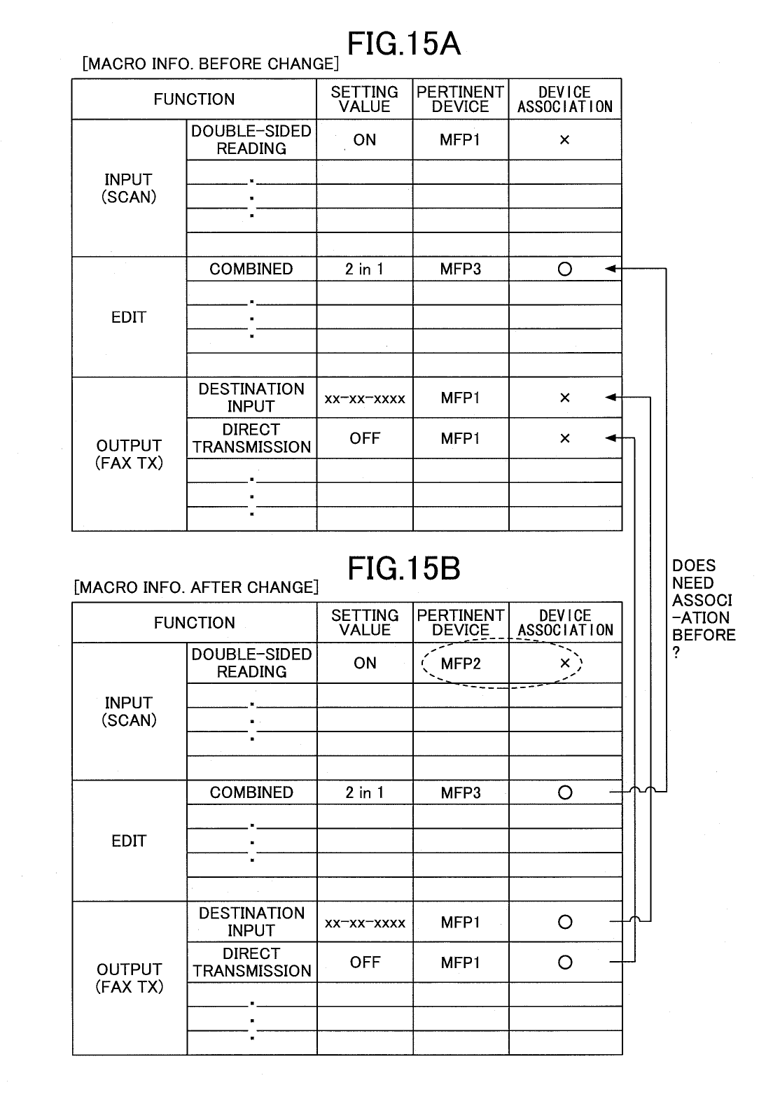

FIG. 15A and FIG. 15B are diagrams for explaining the checking at step S52 in the process of FIG. 14. FIG. 15A shows an example of the macro information before change, and FIG. 15B shows an example of the macro information after change in which it is determined that other functions are executable on MFP 2 by itself. In the macro information of FIG. 15B, a “function” with “O” at the “device association” item denotes a function requiring the device association.

The combinations of the “function” determined as requiring the device association and the “setting value” thereof in FIG. 15B include a combination of the “combined” function and the setting value “2 in 1”, a combination of the “destination input” function and the setting value “xx-xx-xxxx (fax number)”, and a combination of the “direct transmission” function and the setting value “OFF”.

If this macro information is compared with the macro information before change, it can be determined that the “combined” function and the setting value “2 in 1” requires the device association also in the macro information before change. Namely, it is apparent that MFP1 (macro export device) was set to perform the “combined” function with the setting value “2 in 1” using the device association with MFP3.

S54: when a “function” in the macro information before change which does not require the device association is found from among “functions” in the macro information after change requiring the device association, the determining unit (DET) 35 makes the “function” into the object of searching. That is, the determining unit (DET) 35 succeeds the setting value of the “pertinent device” of the macro information before change with respect to the “function” in the macro information before change requiring the device association. Therefore, it is unnecessary to change the “pertinent device” for the “function”. In the example of FIG. 15A, the “pertinent device” of the “combined” function remains unchanged as being MFP3 in the macro information after change.

In this embodiment, the data related to the associate device (such as an address book) can be used without change. For example, in a case of a user name of an address book specific to the associate device being registered for the “destination input” function in the macro information before change, if “the pertinent device” is changed, it is necessary to read the user's fax number from the address book. The same address book is not necessarily registered into the macro import device.

However, by succeeding the setting value of the “pertinent device” in the macro information before change as in this embodiment, the user name of the address book can be read and the time of changing the macro information can be shortened.

When all the “functions” in the macro information after change requiring the device association also require the device association in the macro information before change, the changing process of the macro information is terminated.

When a “function” which doe not require the device association in the macro information before change is found from among the “functions” requiring the device association after change, the searching unit (SR) 33 searches the associate candidate device at step S60, and similar to the Embodiment 1, the determining unit (DET) 35 transmits the inquiry information to the associate candidate device.

As described above, according to this embodiment, changing of the macro information can be minimized and the associate device to perform the required “function” using the device association can be found in a short time.

### Embodiment 3

In this embodiment, searching of the associate candidate device can be omitted by setting to the macro export device the “pertinent device” with respect to a “function” which does not require the device association in the macro information before change among “functions” requiring the device association in the macro information after change. Namely, the “pertinent device” for the “function” which does not require the device association in the macro information before change but requires the device association after the change of the macro information is set to MFP1 (macro export device), and the “pertinent device” can be determined easily.

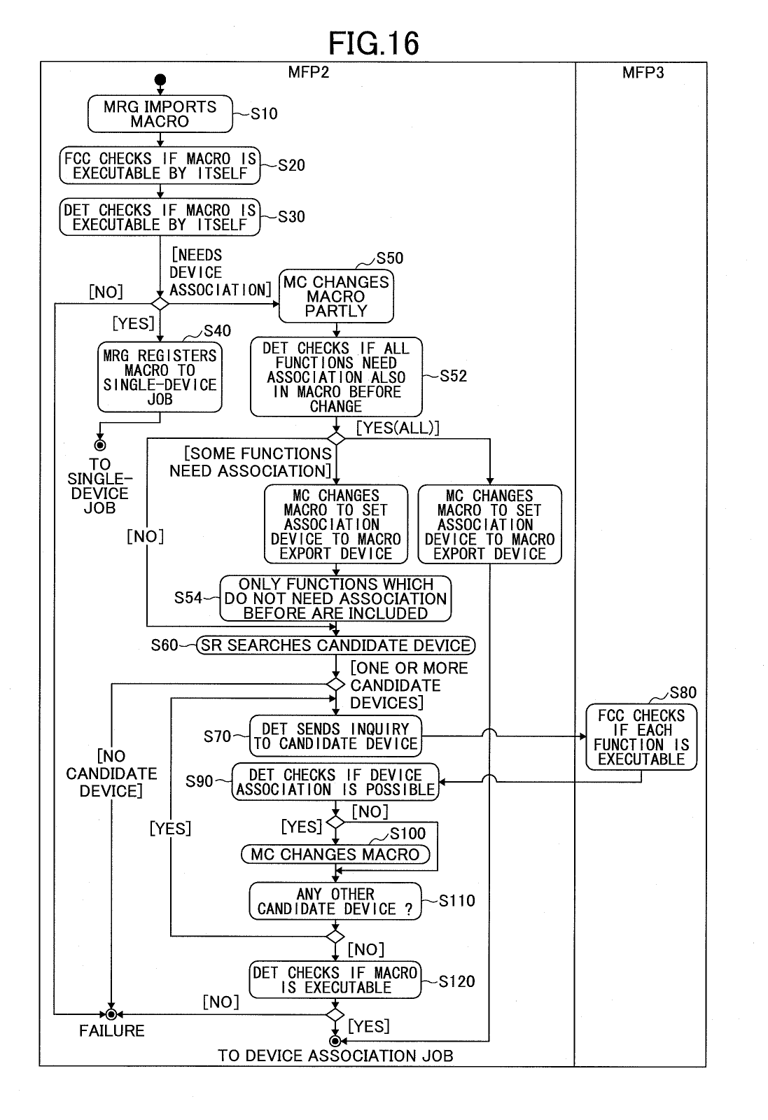

FIG. 16 is a flow diagram for explaining a process performed by a macro import device and an associate candidate device. In FIG. 16, the elements which are the same as corresponding elements in FIG. 14 are designated by the same reference numerals, and a description thereof will be omitted.

The determining unit (DET) 35 checks whether all “functions” requiring the device association in the macro information after change require the device association also in the macro information before change. This checking is the same as the step S52 as in the process of FIG. 14 described above.

(i) When all the “functions” requiring the device association after the change of the macro information require the device association also before the change (when the “association” items for all the functions in FIG. 15A are set to “O”), the searching unit (SR) 33 searches the associate candidate device for each “function” in order to determine the associate device, which is the same as in Embodiment 1.
(ii) When a “function” requiring the device association after the change of the macro information does not require the device association before the change, it can be determined that the “function” in the macro information before change was executable on MFP1 by itself. Hence, the macro changing unit (MC) 36 changes only the “pertinent device” for the “function” not requiring the device association in the changed macro information, so that MFP1 included in the macro information before change may be used as the associate device to perform the “function”. The determining unit (DET) 35 sets the “function” requiring the device association after the change of the macro information but not requiring the device association before the change to the object of searching (S54).
(iii) When all the “functions” requiring the device association after the change of the macro information do not require the device association before the change (or when all the “association” items for all the functions in FIG. 15A are set to “x”), it can be determined that all the “functions” in the macro information before change are executable on MFP1 by itself. The macro changing unit (MC) 36 leaves the “pertinent device” items for the “functions” in the macro information before change unchanged, so that MFP1 included in the macro information before change may be used as the associate device to perform each “function”. In this case, the process of FIG. 16 is completed.

As described above, in this embodiment, changing of the macro information can be minimized and the associate device to perform the function requiring the device association can be found in a short time.

### Embodiment 4

As described above, the searching unit (SR) 33 may search two or more associate candidate devices. In this case, the determining unit (DET) 35 receives inquiry result information from the two or more associate candidate devices. However, there is a case in which the “permission” for the same “function” is redundantly set to “O” according to the inquiry result information received from the two or more associate candidate devices.

In such a case, MFP2 in this embodiment determines one associate device from among the two or more associate candidate devices.

The macro information is imported by the MFP2 (macro import device) in this embodiment when it is the association macro which cooperates with two or more devices, MFP2 selects the associate device so that the associate device can be managed with one, when importing the macro information. For example, the associate devices are narrowed down to one among MFP3 and MFP4.

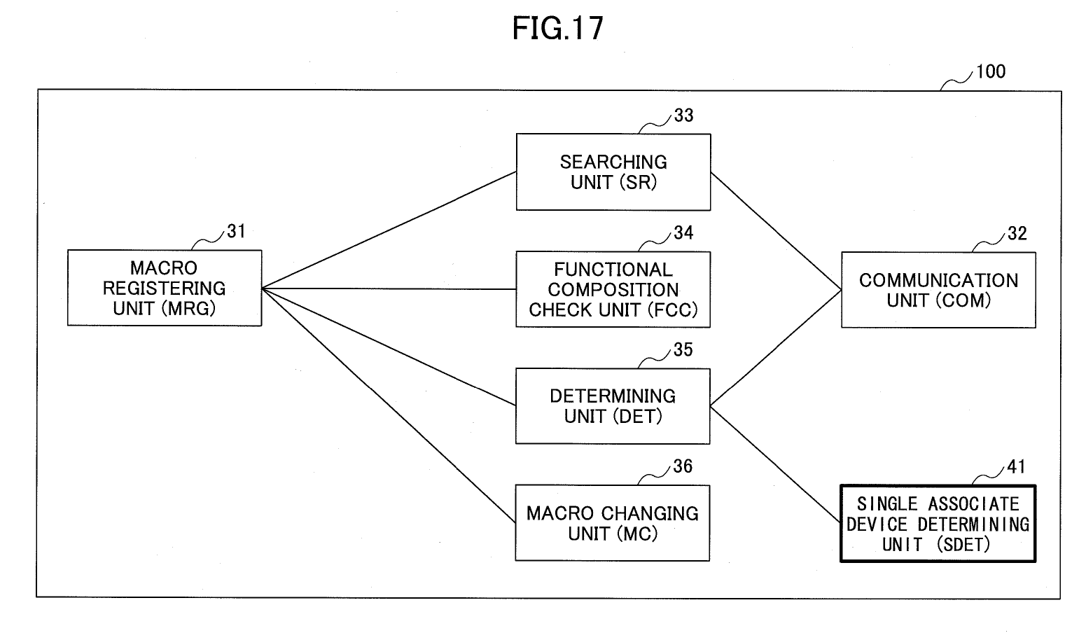

FIG. 17 is a block diagram showing the functional composition of MFP2 of this embodiment. In FIG. 17, the elements which are the same as corresponding elements in FIG. 4A are designated by the same reference numerals, and a description thereof will be omitted.

MFP of this embodiment is configured to include a single associate device determining unit (SDET) 41. The single associate device determining unit (SDET) 41 determines the associate device set as “the pertinent device” so that the associate device may be set to one with reference to two or more inquiry result information.

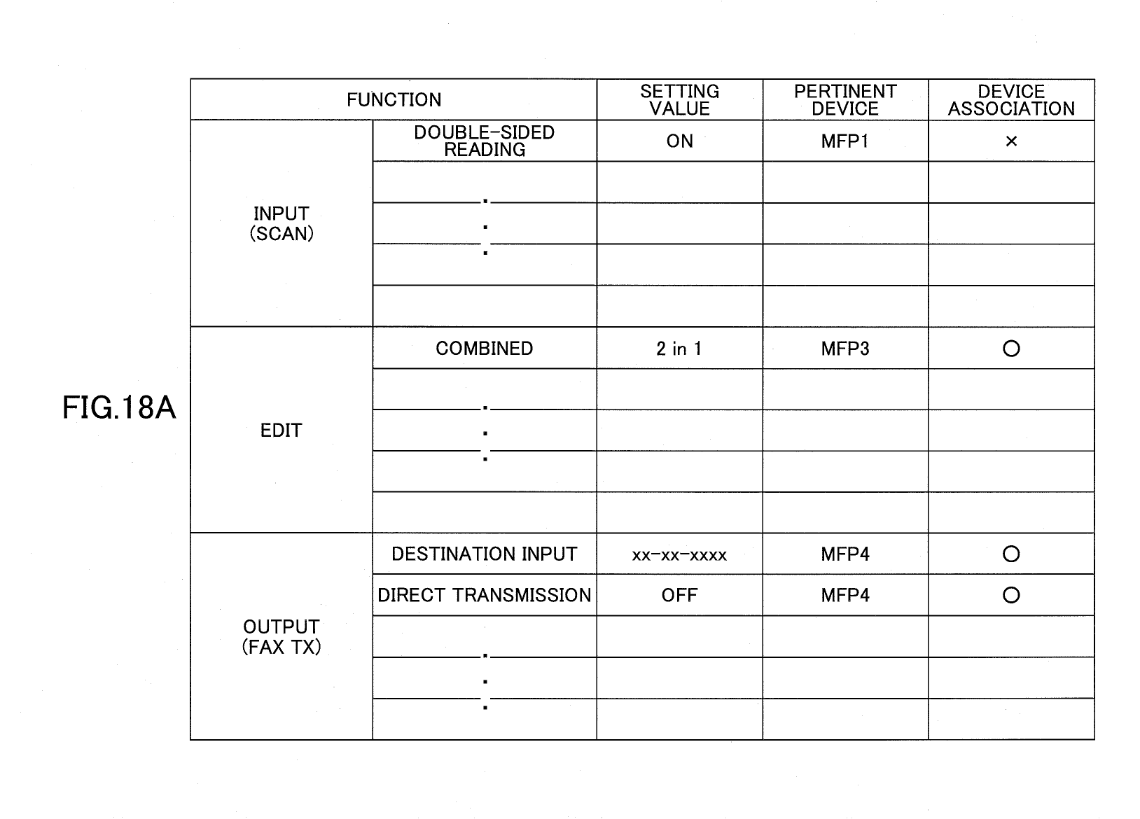

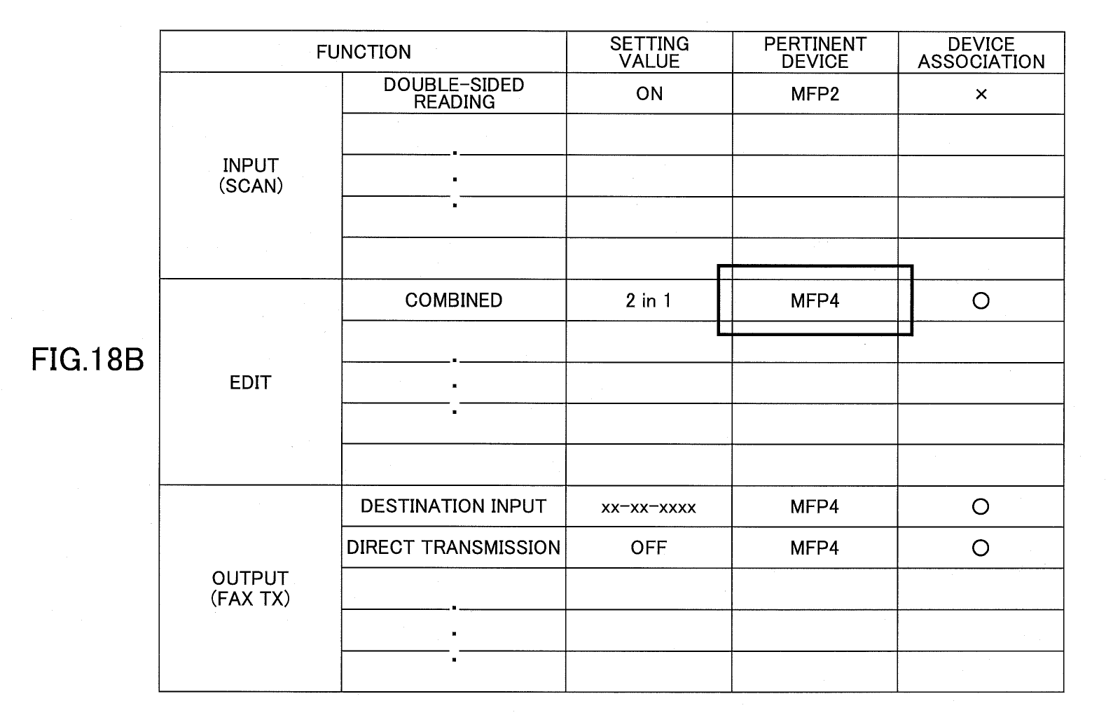

FIG. 18A is a diagram showing an example of macro information for taking in (macro information before change). As is clear from the “pertinent device”, MFP1 performs the “functions” set in this macro information by the device association with MFP3 and MFP4.

It is assumed that the functional composition check unit (FCC) 34 of MFP2 (macro import device) determines that the “input” function of the macro information is executable on the MFP by itself, and determines that the “combined” function with “setting value” of “2 in 1” with respect to the “edit” function, and the “direct transmission” with the “setting value” of “OFF” and the “destination input” with the “setting value” of “xx-xx-xxxx” with respect to the “output” function are not executable on the MFP.

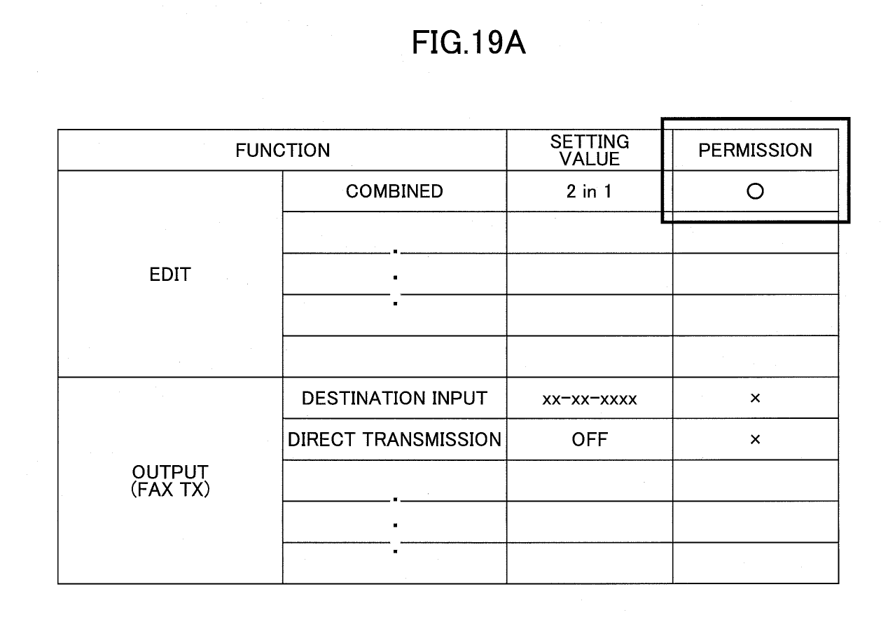

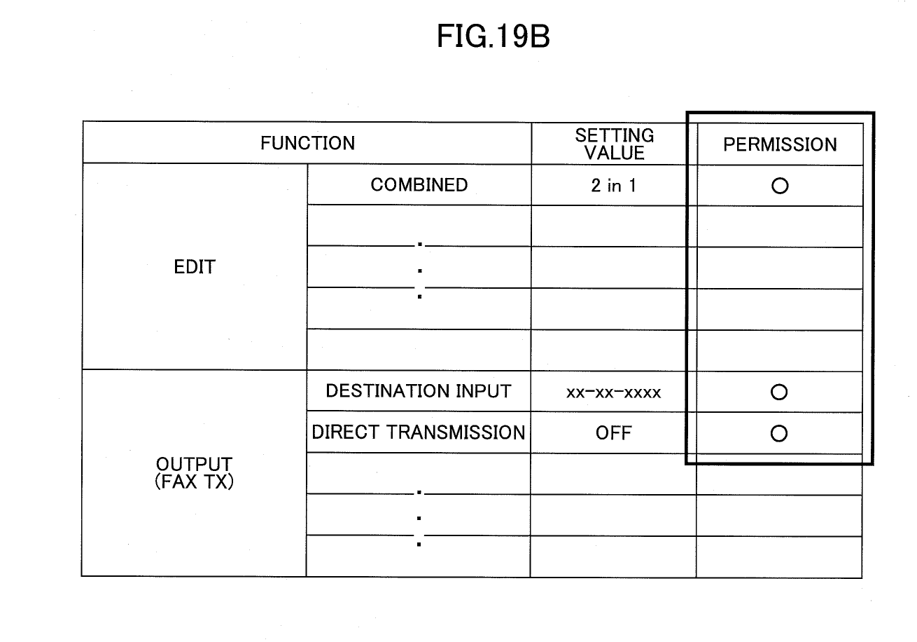

FIG. 19A shows an example of the inquiry result information received from MFP3 and FIG. 19B shows an example of the inquiry result information received from MFP4.

In MFP3″, the “permission” for each of “destination input” and “direct transmission” is set to “x”, and in MFP4, the “permission” for all the “functions” is set to “O”.

Hence, the single associate device determining unit (SDET) 41 of MFP2 selects MFP4 as the device of association place, so as to make the number of the associate devices to one, and changes the “pertinent device” of the macro information.

FIG. 18B shows an example of macro information changed by the macro changing unit (MC) 36. When compared with FIG. 18A, the “pertinent device” item is changed from “MFP3” to “MFP4”.

Since a “function” set in the macro information which two or more pieces of the associate candidate device which MFP2 searched shared with carrying out like this can be performed with one piece of the associate device, a network load at the time of job execution can be made to reduce.

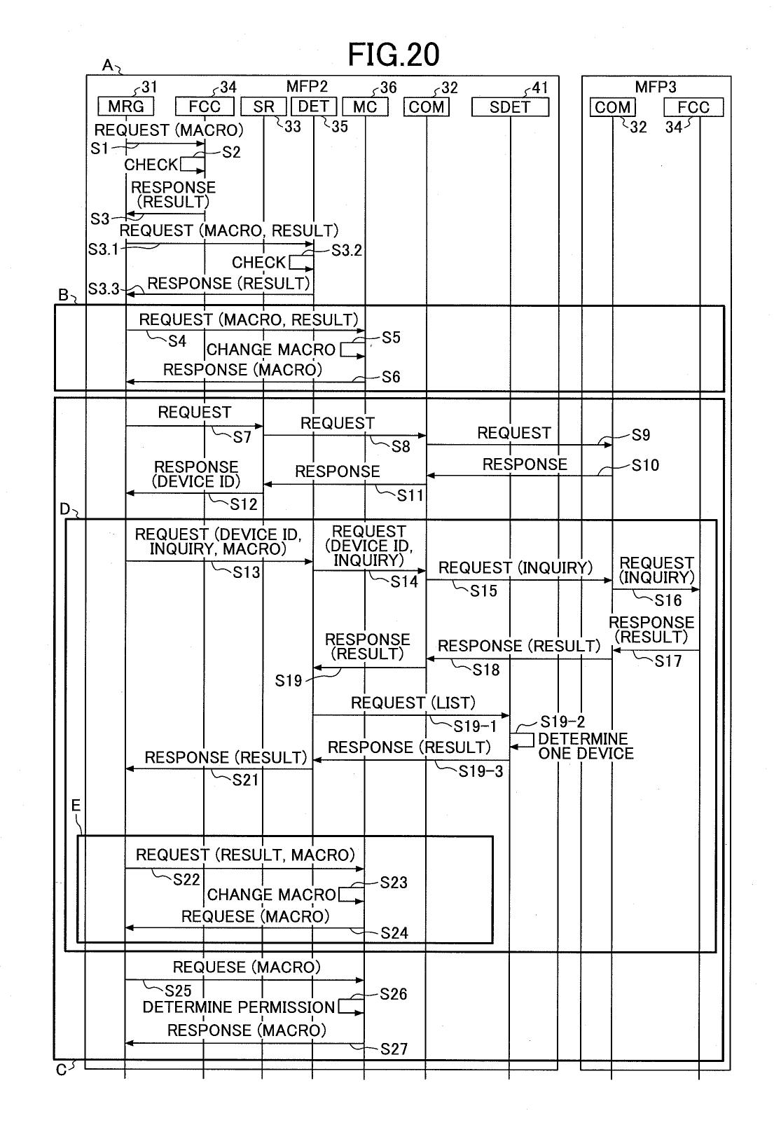

FIG. 20 is a sequence diagram for explaining how to import macro information in this embodiment. In FIG. 20, the elements which are the same as corresponding elements in FIG. 13 are designated by the same references and a description thereof will be omitted.

S19-1: if the determining unit (DET) 35 asks and result information is received, the determining unit (DET) 35 transmits the all the inquiry result information to single associate device determining unit (SDET) 41. That is, single associate device determining unit (SDET) 41 can receive a list of inquiry result information.
S19-2: single associate device determining unit (SDET) 41 determines the associate device set as “the pertinent device” so that the associate device may be set to one with reference to two or more inquiry result information. The determined associate device is called single associate device result information.

When the number of the associate devices is not necessarily set to one, the single associate device determining unit (SDET) 41 determines the associate device set as “the pertinent device” so as to make the number of the associate devices the smallest.

S19-3: the single associate device determining unit (SDET) 41 transmits the single associate device result information to the determining unit (DET) 35. Subsequent processes are the same as that of Embodiment 1.

The determining unit (DET) 35 determines whether it is necessary to change the macro information based on the single associate device result information, and sends the check result information which is the check result to the macro registering unit (MRG) 31.

When the “function” can be performed by association, the macro registering unit (MRG) 31 transmits the check result information and the macro information to the macro changing unit (MC) 36, and requests the changing of the macro information. Thereby, the macro changing unit (MC) 36 can change the “pertinent device” of macro information, as shown in FIG. 18B.

As described above, in this embodiment, the network load at the time of macro execution and the execution time of the macro can be reduced by making the number of the associate devices into one or the minimum.

### Embodiment 5

In the Embodiment 4, the associate device is determined as one device. In this embodiment, two or more associate devices are registered in the macro information, and MFP2 which determines one of the associate devices at the time of execution of a macro will be described.

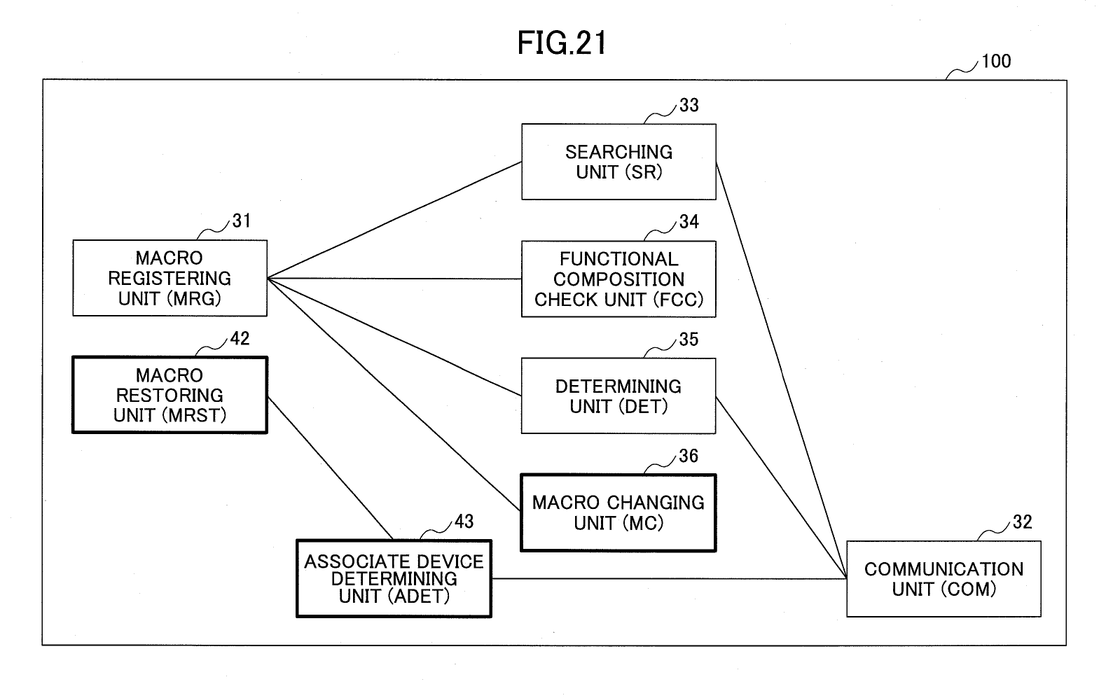

FIG. 21 is a block diagram showing the functional composition of MFP2 of this embodiment. In FIG. 21, the elements which are the same as corresponding elements in FIG. 4A are designated by the same reference numerals, and a description thereof will be omitted.

As shown in FIG. 21, MFP2 of this embodiment includes a macro restoring unit (MRST) 42 and an associate device determining unit (ADET) 43. The macro restoring unit (MRST) 42 converts macro information into a command and a parameter which are executable by MFP2. The macro is performed when the command and the parameter are executed by MFP2.

The associate device determining unit (ADET) 43 determines one associate device dynamically when two or more “pertinent devices” set for one “function” in the macro information.

There are various methods of determining one associate device. For example,

(i) By receiving an operating condition of each of MFPs to perform the macro, and MFP which can perform the “function” immediately is determined as the associate device of the “function”.
(ii) The “function” for the input process is assigned to MFP2 (macro import device), the “function” for the edit and output processes is assigned to other MFPs and the “pertinent device” is determined so as to reduce the number of the associate devices.

Although the macro changing unit (MC) 36 is provided as in the preceding embodiment, the macro changing unit (MC) 36 of this embodiment has the “function” to set two or more the associate device as the “pertinent device” of macro information.

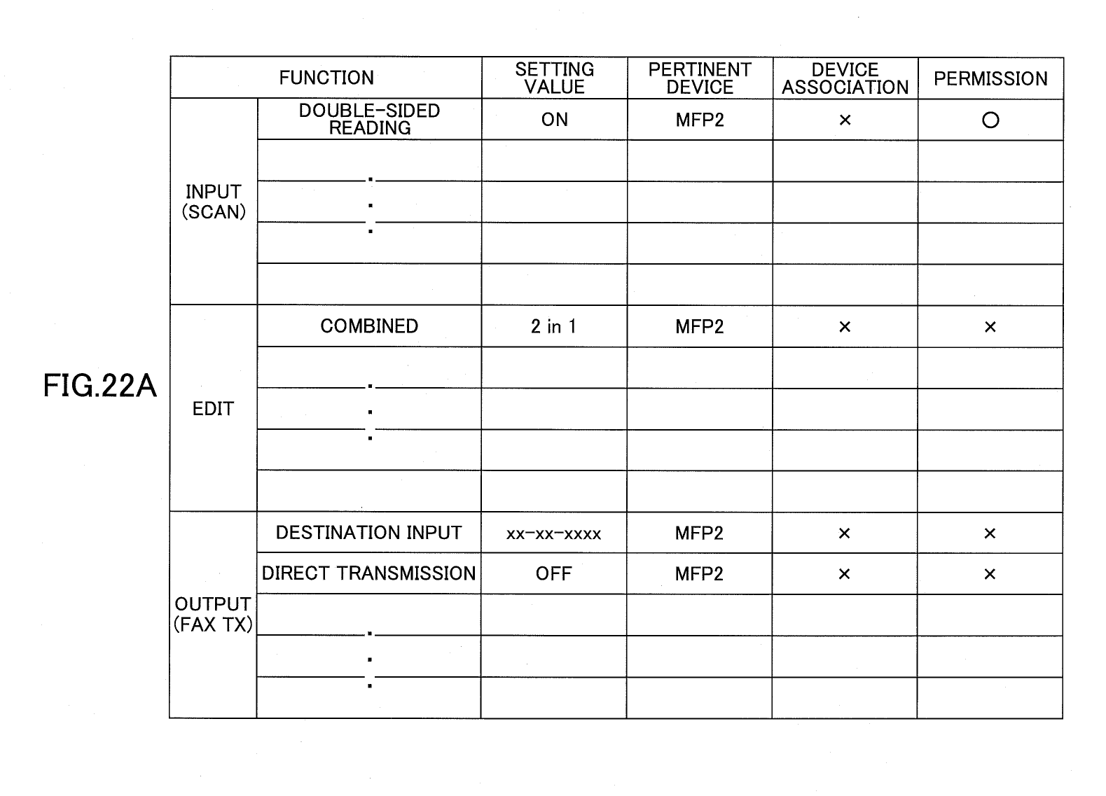

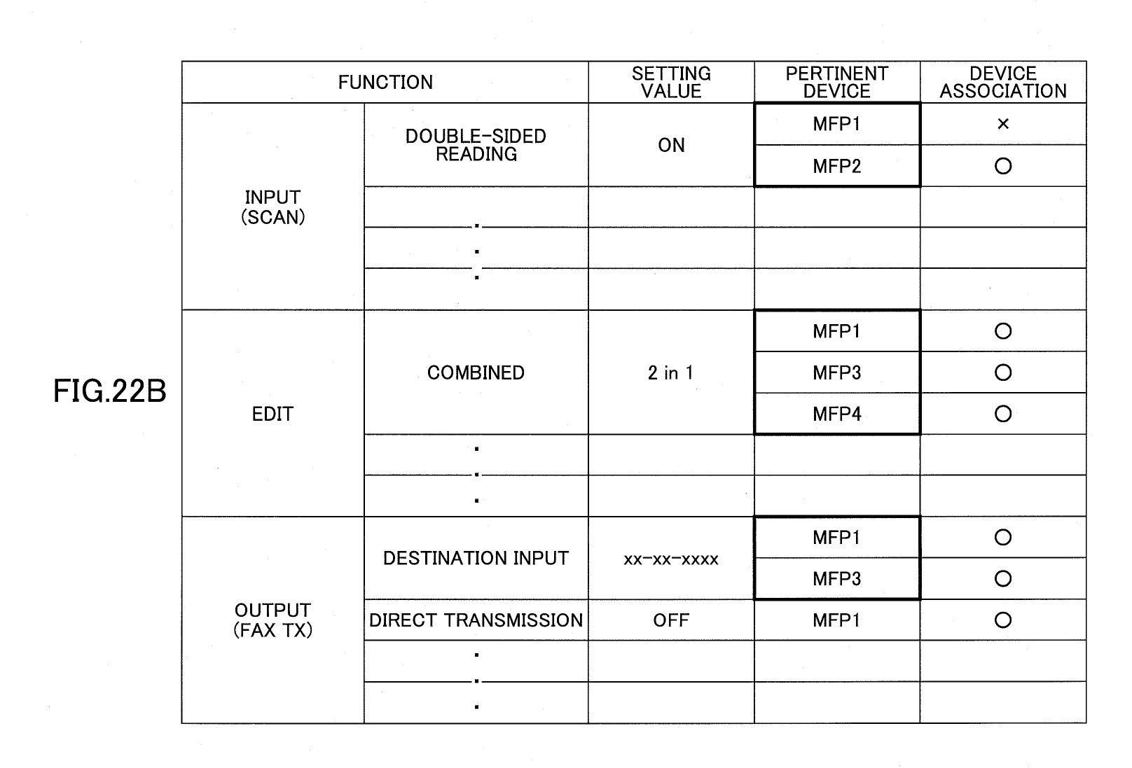

FIG. 22A and FIG. 22B are diagrams for explaining changing the macro information in this embodiment. FIG. 22A shows an example of the checking result information and FIG. 22B shows an example of the macro information changed by the macro changing unit (MC) 36.

As shown in FIG. 22A, “permission” of the “double-sided reading” function is “O”, “permission” of the “combined” function is “x”, “permission” of the “destination input” function is “x”, and “permission” of the “direct transmission” function is “x”. In this case, in the Embodiment 1, inquiry information is transmitted to the associate candidate device by the determining unit (DET) 35 about a “function” which is executable on the MFP by itself.

In this embodiment, the determining unit (DET) 35 transmits inquiry information to the associate candidate device about all the “functions” in the macro information. Thereby, when the “function” is used by the macro import device (MFP2), the macro can be performed by using the device association.

For example, MFP2 receives inquiry result information indicating that the “double-sided reading” is executable on MFP1 (also MFP2), the “combined” function is executable on MFP1, MFP3 and MFP4, the “destination input” is executable on MFP1 and MFP3, and the “direct transmission” is executable on MFP1. In this case, the macro changing unit (MC) 36 of MFP2 changes the macro information, as shown in FIG. 22B.

Because two or more device identifiers of the associate devices are associated with one “function”, the associate device determining unit (ADET) 43 can determine one of the associate devices for each function.

For example, when the selecting method of (ii) is used, the associate device determining unit (ADET) 43 determines that the pertinent device of the input function (double-sided reading) is MFP2, and the pertinent device of the edit and output functions is MFP1, so as to make the number of the associate devices smallest. Thus, it is possible to dynamically assign at the time of execution the associate devices from two or more “pertinent devices”.

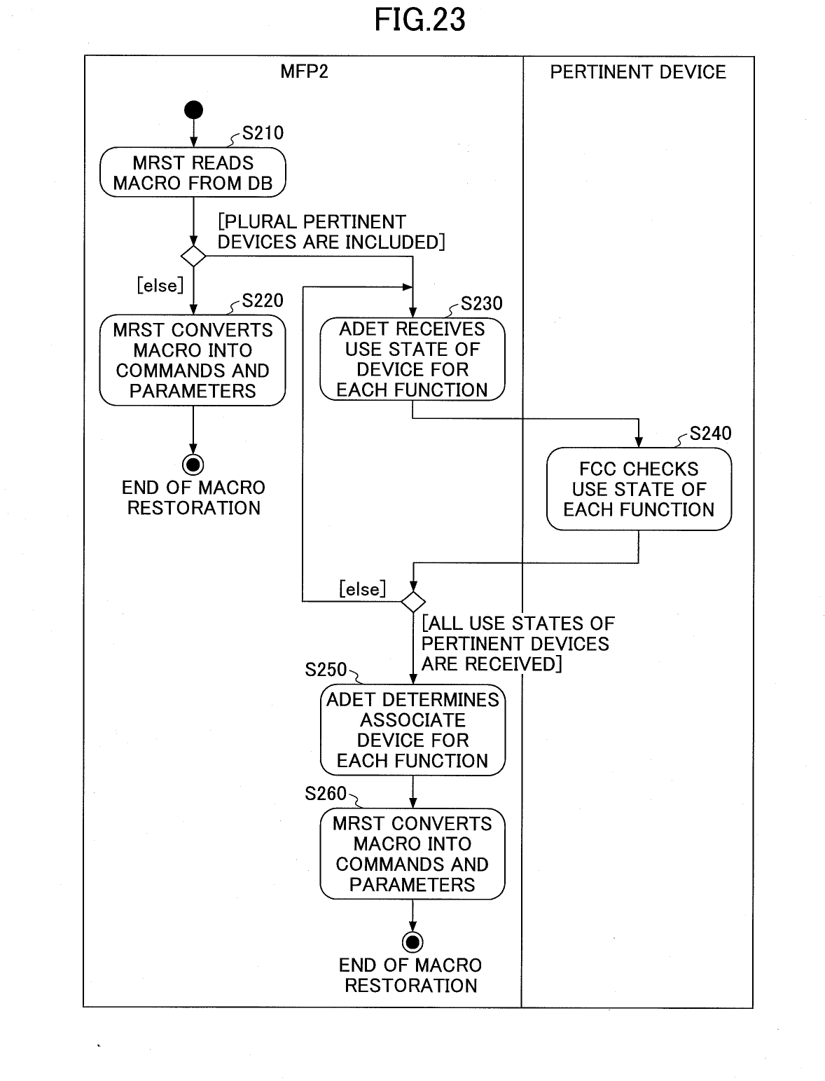

FIG. 23 is a flow diagram showing a process in which the macro restoring unit (MRST) 42 determines the associate device at the time of execution of a “function” set in the macro information.

The process of FIG. 23 is started if a user operates the operation panel 17, specifies macro information and inputs the execution operation. First, the macro restoring unit (MRST) 42 reads macro information of an object restored from macro information database (DB) 37 (S210).

It is determined whether two or more “pertinent devices” are registered in the macro information. When two or more devices are not registered, the macro restoring unit (MRST) 42 converts each function of the macro information into a command and a parameter without change, and the macro restoring process is completed (S220).

When two or more “pertinent devices” are registered in the macro information, the macro restoring unit (MRST) 42 requests the associate device determining unit (ADET) 43 to determine the associate device. The associate device determining unit (ADET) 43 receives an operating condition of the “pertinent device” for each function (S230).

The functional composition check unit (FCC) 34 of the “pertinent device” which received an inquiry of an operating condition answers an operating condition for every function (S240).

The associate device determining unit (ADET) 43 receives the operating condition about all the “pertinent devices” registered for “function”.

If the operating condition is received about all the “pertinent devices”, the associate device determining unit (ADET) 43 will determine preferentially the “pertinent device” which is not using a “function” for every function as the associate device (S250).

When the “function” with two or more “pertinent device” is not being used, the associate device is determined as order with early registration to macro information, or early order of a response.

The associate device determining unit (ADET) 43 notifies the associate device determined for every function to the macro restoring unit (MRST) 42. Thereby, the macro restoring unit (MRST) 42 determines the associate device, generates a command and a parameter of the “function” required for execution, and can perform the macro.

In this embodiment, according to the operating condition of “the pertinent device”, the associate device can be determined at the time of execution by registering two or more devices in the macro information as “pertinent devices” of the “function”.

Therefore, if one or more of the “pertinent devices” registered in the macro information is available, the “function” set in the macro information can be performed.

### Embodiment 6

In the Embodiment 5, the associate device determining unit (ADET) 43 determines the associate device from among two or more “pertinent devices”. In this embodiment, an MFP which prompts a user to select the associate device from among two or more “pertinent devices” will be described.

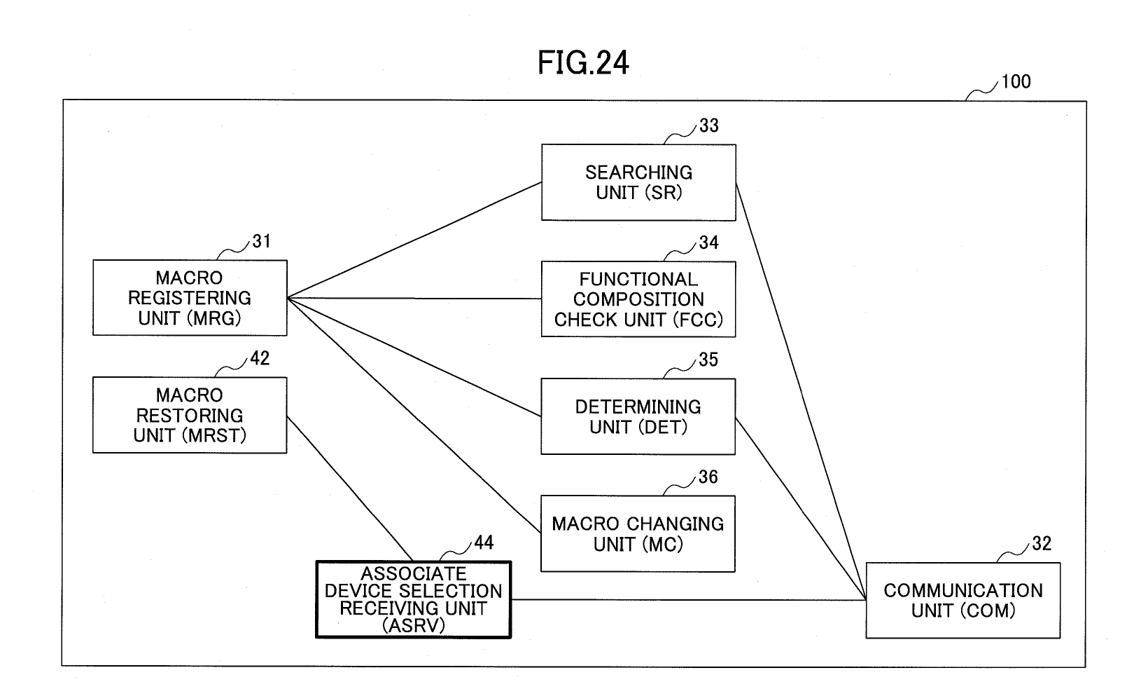

FIG. 24 is a block diagram showing the functional composition of the MFP of this embodiment. In FIG. 24, the elements which are the same as corresponding elements in FIG. 21 are designated by the same reference numerals, and a description thereof will be omitted.

As shown in FIG. 24, MFP2 of this embodiment further includes an associate device selection receiving unit (ASRV) 44. When MFP2 performs the macro, the associate device selection receiving unit (ASRV) 44 urges the user to select the “pertinent device” in the selection screen and receives the selection from the user.

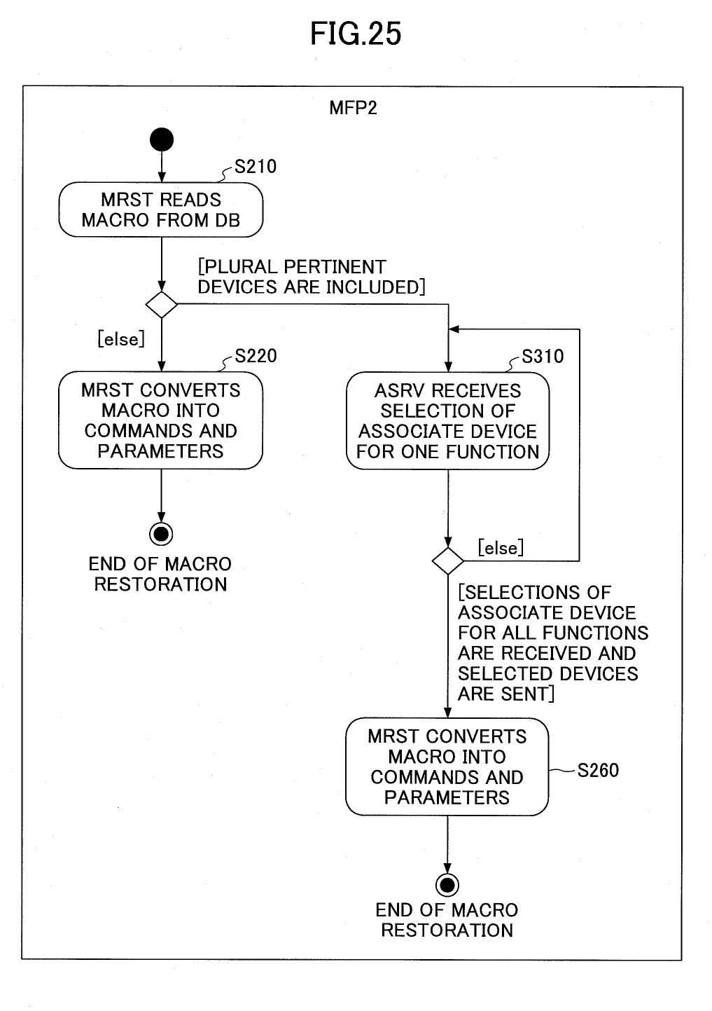

FIG. 25 is a flow diagram from explaining a process in which the macro restoring unit (MRST) 42 determines an associate device at a time of execution of a “function” set in the macro information. In FIG. 25, the steps which are the same as corresponding steps in FIG. 23 are designated by the same reference numerals and a description thereof will be omitted.

When two or more “pertinent devices” are registered into macro information, the associate device selection receiving unit (ASRV) 44 urges the user to select the associate device (S310).

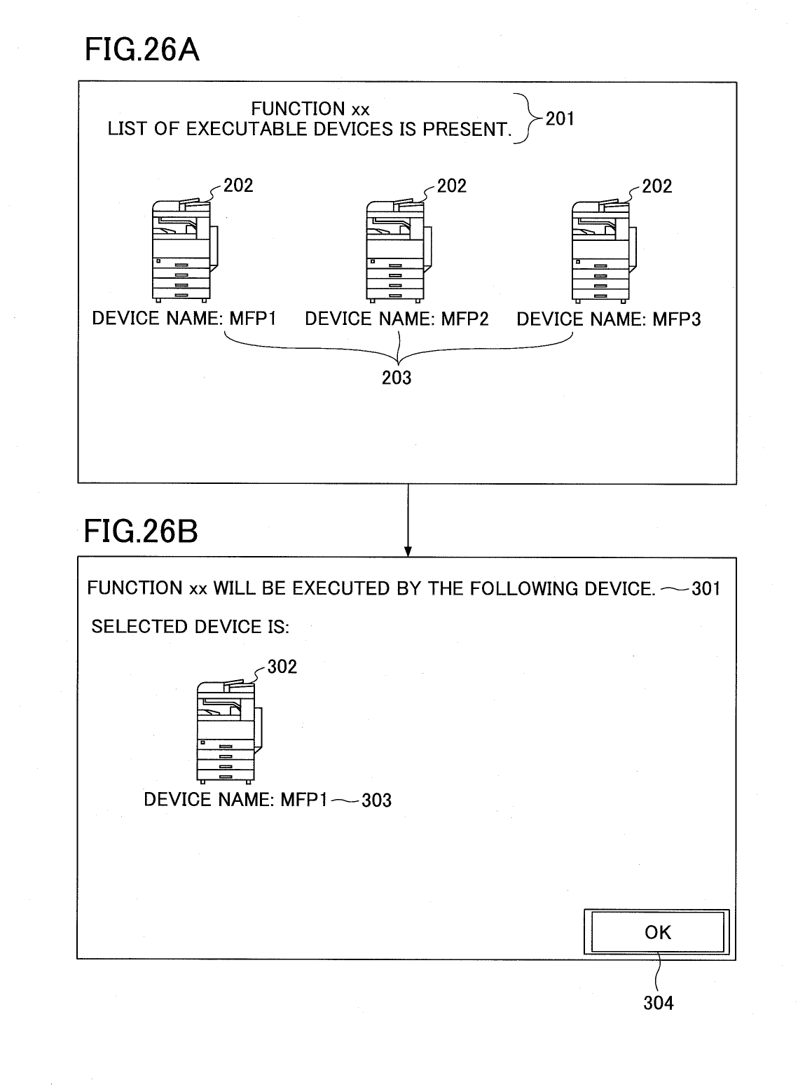

FIG. 26A and FIG. 26B are diagrams showing examples of selection screens displayed on the operation panel 17. The associate device selection receiving unit (ASRV) 44 displays a selection screen as shown in FIG. 26A for each function in which two or more “pertinent devices” are registered into macro information. Namely, a message 201 indicating “function xx: a list of operation executable devices is present”, and identification information (device name) 203 and icons 202 indicating all the “executable devices” are displayed on the operation panel 17 as shown in FIG. 26A.

Since the user can distinguish the actual device by identification information of the “pertinent device”, the user can select the MFP which performs the “function”. The device nearest to the user or the device (recently introduced device) with the highest processing speed may be selected.

If the user selects the “pertinent device” by contacting the operation panel 17, the associate device selection receiving unit (ASRV) 44 receives identification information of the selected “pertinent device”. Then, the selection screen as shown in FIG. 26B is displayed.

In FIG. 26B, a message 301 indicating that “the function xx will be performed by the following device”, identification information 303 of the selected “executable device”, and the icon 302 thereof are displayed. If the user depresses the OK button 304, the associate device for one “function” will be determined.

The associate device selection receiving unit (ASRV) 44 repeats displaying of the selection screens of FIG. 26A and FIG. 26B until the associate device is determined for all the “functions”. The associate device selection receiving unit (ASRV) 44 will notify the associate device chosen for every function to the macro restoring unit (MRST) 42, if selection is received for all the “pertinent devices”.

Thereby, the macro restoring unit (MRST) 42 determines the associate device, generates a command and a parameter of a “function” required for execution, and can perform macro information (S260).

In this embodiment, the user can select the associate device arbitrarily at the time of execution of a “function” set in the macro information. It is possible to select the device nearest to the user's position, or the device with the highest processing speed. It, is possible to improve the convenience of use of the information processing device.

### Embodiment 7

In the Embodiment 1, the determining unit (DET) 35 of MFP2 (macro import device) determines whether the macro is executable on MFP2 by itself or by using the device association.

However, for example, when it is determined that a failure of import of macro information occurs as in FIG. 10, MFP2 cannot import the macro information. In this case, a user may move to another device MFP3 or MFP4 and may import the macro information therein again. However, such operation will be troublesome.

In this embodiment, when MFP2 cannot import the macro information for a certain reason, a process in which MFP2 requests another MFP to register the macro information will be described.

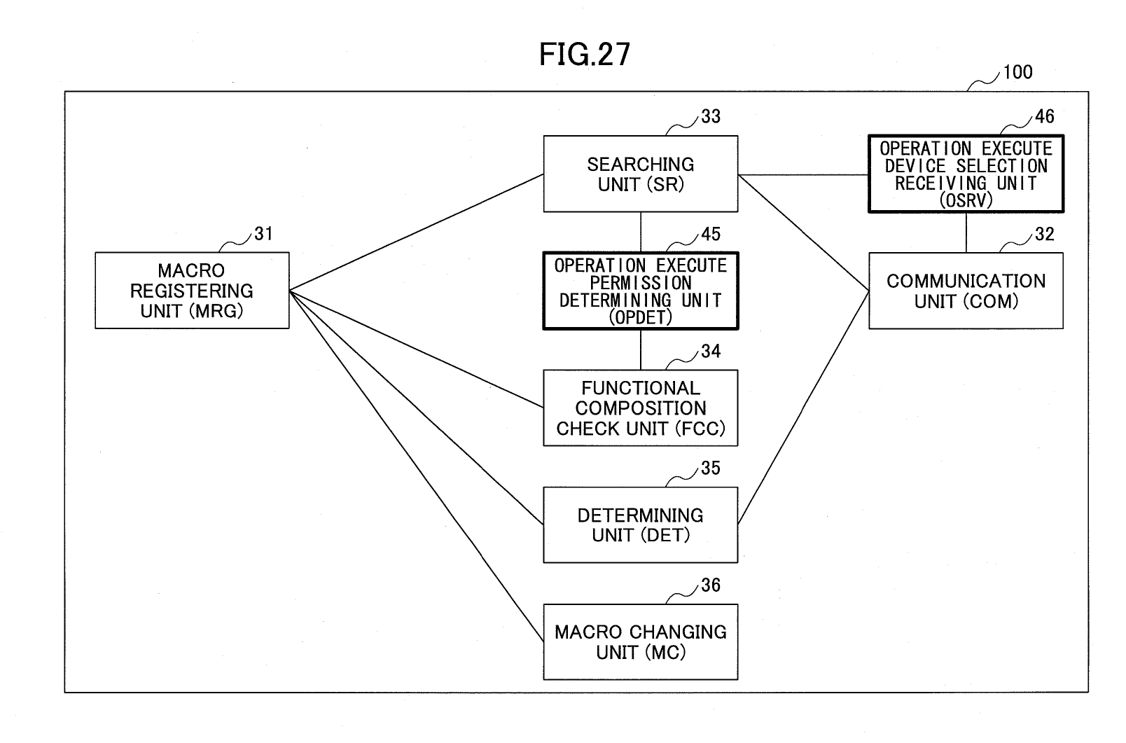

FIG. 27 is a block diagram showing the functional composition of MFP2 of this embodiment. In FIG. 27, the elements which are the same as corresponding elements in FIG. 4A and FIG. 4B are designated by the same reference numerals, and a description thereof will be omitted.

MFP2 of this embodiment is constructed to further include an operation execute permission determining unit (OPDET) 45 and an operation execute device selection receiving unit (OSRV) 46.

The operation execute permission determining unit (OPDET) 45 determines whether the macro information can be imported. The case where it is determined that the macro information cannot be imported corresponds to the case where occurrence of a “failure of introduction of macro information” is determined as in FIG. 10.

There is a case where MFP2 is unable to actually perform the macro even if the determining unit (DET) 35 determines that a “function” set in the macro information is executable by using the device association. For example, a case where an input function registered in the macro information is related to using a removable recording medium, such as a USB memory or an SD card, (in which a document is stored therein) is conceivable.

Even when the host of the recording medium is not provided in MFP2, the determining unit (DET) 35 determines that to perform the input function set in the macro information is executable on MFP2 if the “pertinent device” using the device association has the host of the recording medium. The image data of the document cannot be input unless the user moves with the USB memory.

For this reason, the operation execute permission determining unit (OPDET) 45 determines that the macro is not executable on MFP2 (namely, the macro information cannot be imported) if there is, for example, an input “function” which cannot be performed on MFP2 by itself.

When two or more MFP3 which can register macro information exist, the operation execute device selection receiving unit (OSRV) 46 displays a list of the two or more MFP3 on the operation panel 17, and receives selection of one of the two or more MFP3 as a registration place from a user.

In this manner, even if the user does not move, the macro information can be registered into any of the MFPs which perform the device association mutually.

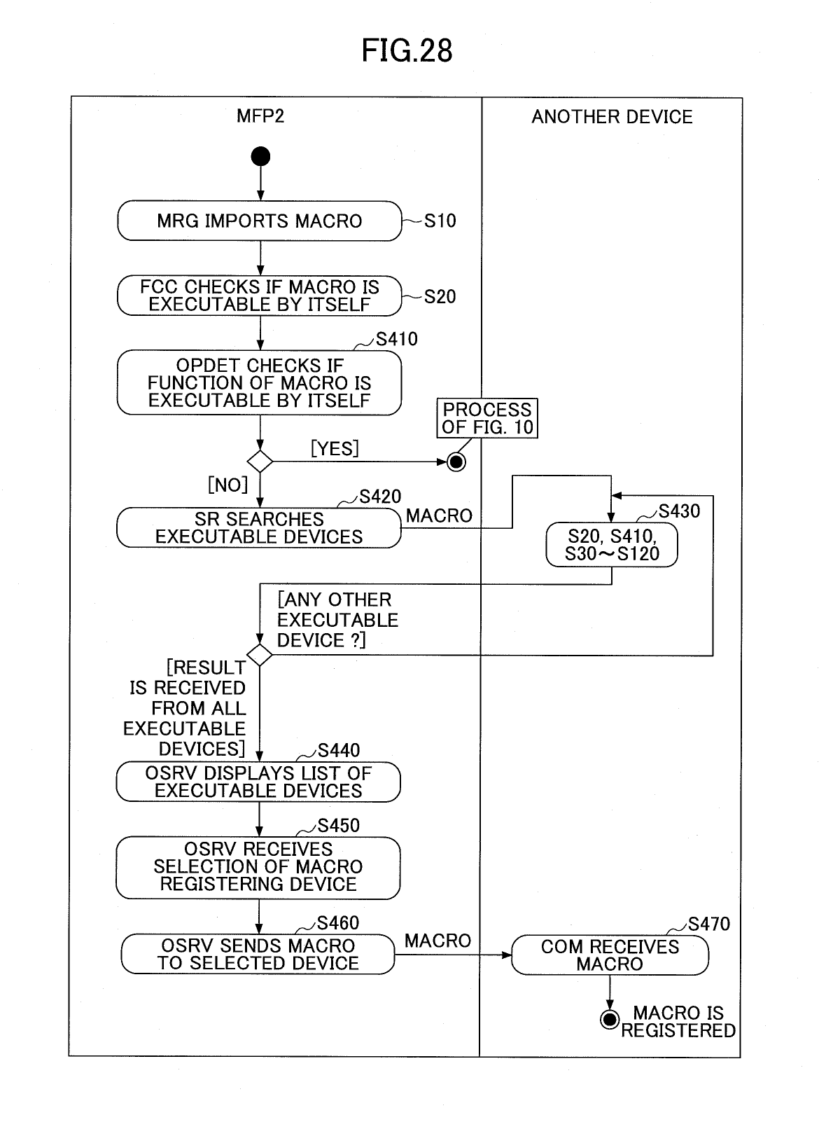

FIG. 28 is a flowchart diagram for explaining a process in which MFP2 registers macro information into itself.

First, the macro registering unit (MRG) 31 imports macro information to MFP2 and starts macro registration processing (S10).

Next, the functional composition check unit (FCC) 34 of MFP2 determines whether each function of the macro information to be imported is executable on the MFP by itself (S20). The algorithm of the checking is the same as described above.

Next, the operation execute permission determining unit (OPDET) 45 determines whether based on a determined result of whether to be able to perform a “function” included in macro information, the MFP2 can perform a macro by itself which the functional composition check unit (FCC) 34 performed (S410). In this case, it is determined whether all the input “functions” are executable on MFP2 by itself. When the operation execute permission determining unit (OPDET) 45 determines that the “functions” contained in the macro information are executable, a process after step S30 of FIG. 10 “it is determined whether the determining unit is executable on the MFP by itself” is performed.

On the other hand, when it is determined by the operation execute permission determining unit (OPDET) 45 that any “function” contained in the macro information is not executable, the searching unit (SR) 33 searches the operation execute device (S420). That is, the executable device not for one “function” but for the entire macro information will be searched.

For this reason, the searching unit (SR) 33 transmits the macro information to all the other devices which are connected via the network, and asks whether the device is executable in that macro information. Other device which received macro information performs processing after step S20, S410, and S30 in FIG. 10, and determines whether the macro is executable (S430).

Each device may associate with another device and may perform macro information. Each device which received macro information transmits a check result to MFP2.

The operation execute permission determining unit (OPDET) 45 receives a check result from each of the searched MFPs. If the check results are received from all the MFPs, the operation execute device selection receiving unit (ODET) 46 displays a list of executable devices which can execute the “function” contained in the macro information on the operation panel 17 (S440).

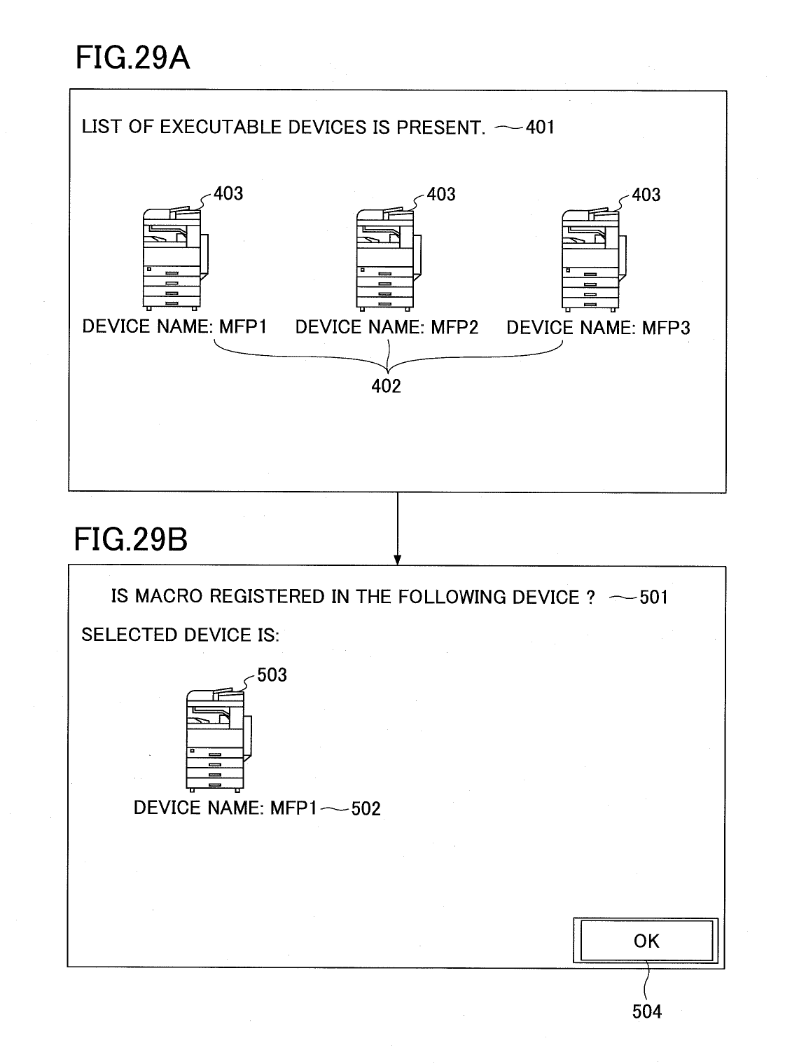

FIG. 29A and FIG. 29B are diagrams showing examples of selection screens displayed on the operation panel 17. All the “functions” by which operation execute device selection receiving unit (ODET) 47 is contained in the macro information or associates and identification information (device name) 402, icons 403, and a message 401 of “showing a list of executable device” of the executable “pertinent device” are displayed on the operation panel 17 as shown in FIG. 29A.

The user can select the device which registers macro information (S450). If the user selects one MFP by contacting the operation panel 17, the operation execute device selection receiving unit (OSRV) 46 receive the identification information of the selected MFP. Then, a selection screen as shown in FIG. 29B is displayed.

In the selection screen of FIG. 29B, a message 501 asking the user “whether macro registration is performed to the following device”, the identification information 502 and the icon 503 of the selected device are displayed. If the user depresses the OK button 504, the operation execute device selection receiving unit (OSRV) 46 transmits the macro information to the device selected by the user (S460).

The MFP which can execute the “functions” included in the macro information receives the macro information, and the MFP registers the macro information into the macro information database (DB) (S470).

### Embodiment 8

In the preceding embodiment, the user selects the registration place of macro information. In this embodiment, an MFP which automatically determines a registration place of macro information will be explained.

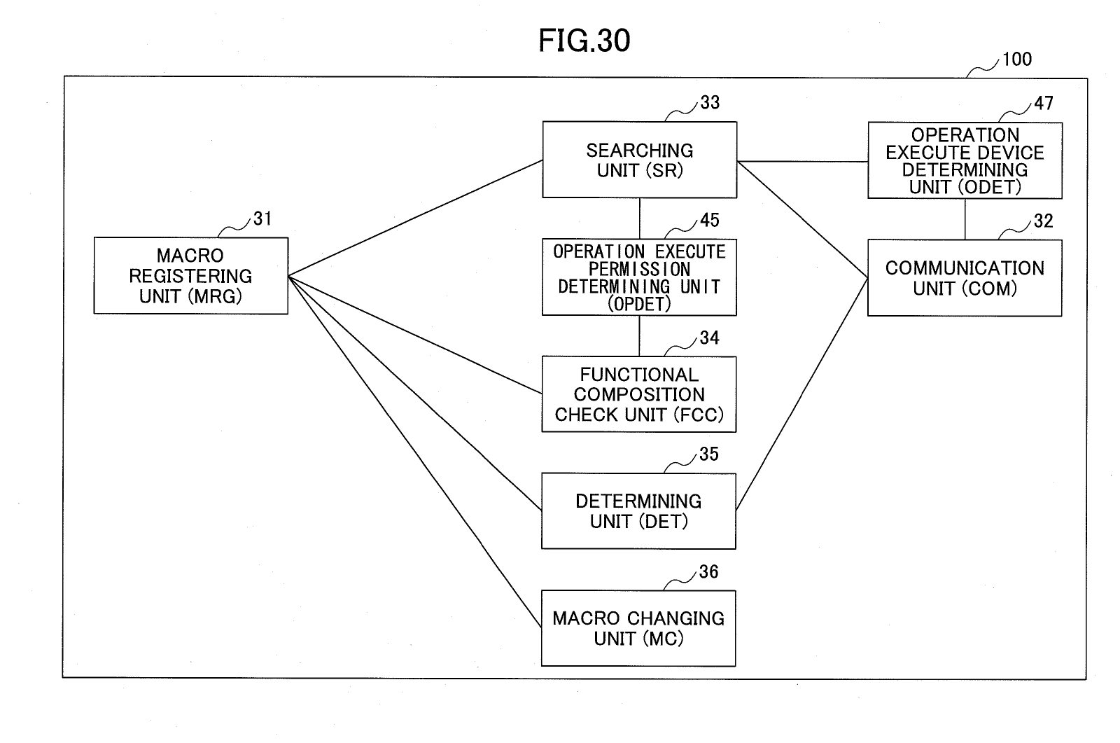

FIG. 30 is a block diagram showing the functional composition of the MFP of this embodiment. In FIG. 30, the elements which are the same as corresponding elements in FIG. 27 are designated by the same reference numerals, and a description thereof will be omitted. As shown in FIG. 30, the MFP of this embodiment includes an operation execute device determining unit (ODET) 47.

When a plurality of MFPs which are executable the macro are present, the operation execute device determining unit (ODET) 47 determines one of the MFPs as the macro registering device which is registered in MFP2 (macro import device). There are the following criteria as criteria for selecting the MFP of the registration place.

(i) A device with a large number of times of execution of an associate job is preferentially determined.

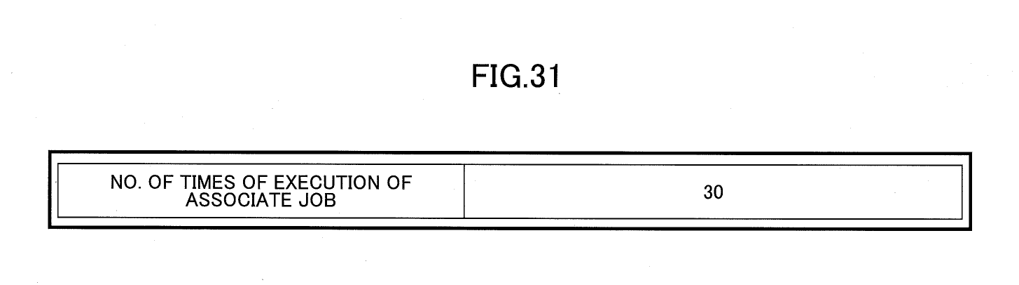

FIG. 31 shows an example of a data structure of the number of times of association job execution. When other MFPs perform a job by using the device association, each MFP offers a certain “function”. The number of times of execution of the association job is counted in each MFP. Hence, in an MFP which frequently offers a “function” by the device association, the number of times of execution of the association job becomes large.

The operation execute device determining unit (ODET) 47 receives the number of times of execution of the association job from each of other MFPs and selects preferentially the device with the largest number of times of execution of the association job.

(ii) A device with a small physical distance from the macro import device (MFP2) is preferentially determined. In order to compare physical distance, each MFP stores the distance information with respect to other MFPs in the HDD 14 beforehand. Alternatively, a GPS receiver may be provided in the MFP and position information detected by the GPS receiver may be used.
(iii) A device with the smallest response time is preferentially determined.

In any case of (i)-(iii), the operation execute device determining unit (ODET) 47 eliminates the device originally registered in the macro information from a candidate device for selection. For this reason, the operation execute device determining unit (ODET) 47 eliminates the applicable device by receiving the device identifier of the macro generating device included in the macro information, and selects the macro registering device.

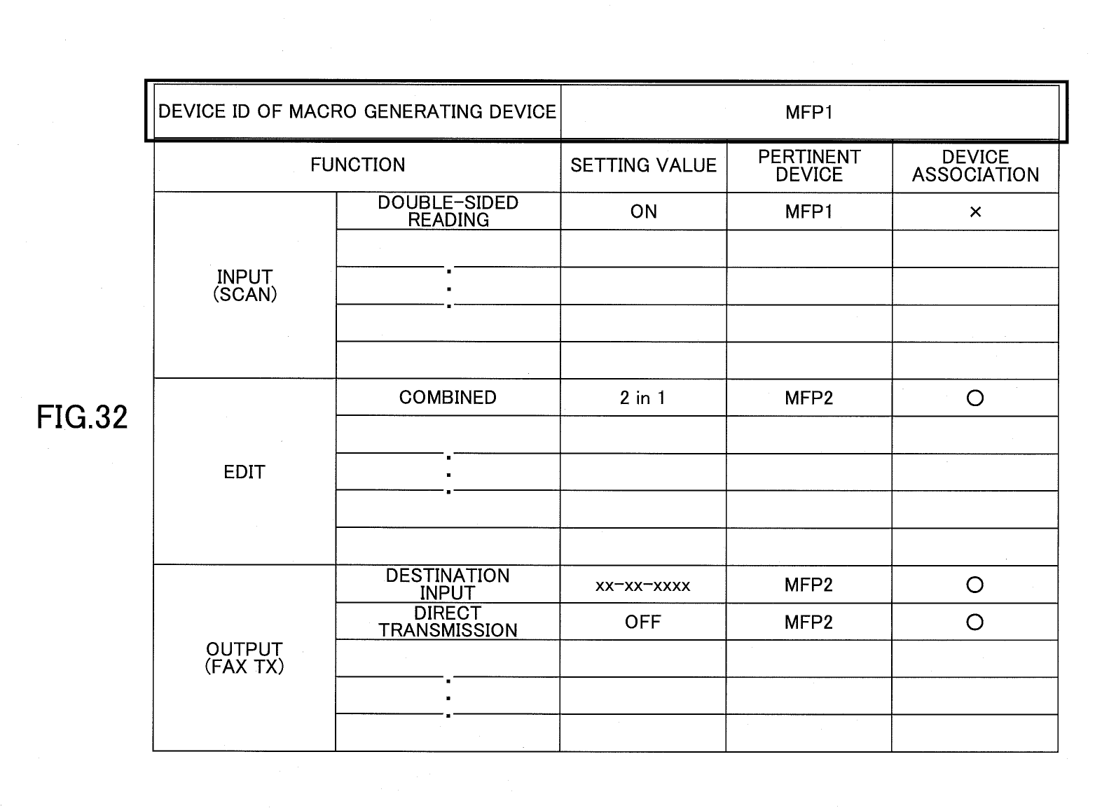

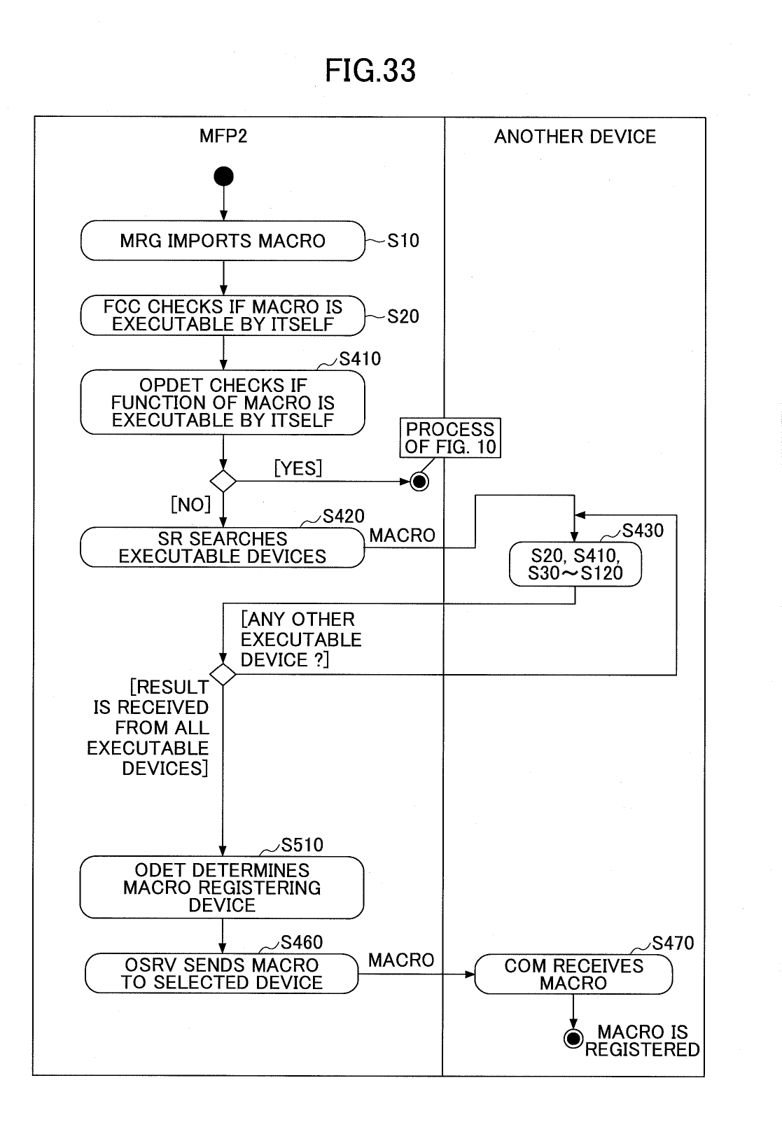

FIG. 32 is a diagram showing an example of a device identifier of a macro generating device set as in the macro information. In this embodiment, the macro generating device and the macro registering device are used in the same meaning. In FIG. 32, the device identifier (device ID) of the macro generating device is MFP1. The operation execute device determining unit (ODET) 47 eliminates MFP1 and selects the macro registering device. It is possible to prevent registering two macro registering devices in the macro information.

FIG. 33 is a flow diagram showing a process in which MFP2 registers macro information therein by itself. In FIG. 33, the steps which are the same as corresponding steps in FIG. 28 are designated by the same reference numerals, and a description thereof will be omitted.

As shown in FIG. 33, at step S430, the operation execute device determining unit (ODET) 47 receives a check result from each of the searched MFPs. At this time, the operation execute device determining unit (ODET) 47 also receives the number of times of association job execution.

The operation execute device determining unit (ODET) 47 determines an MFP with the largest number of times of association job execution as a candidate for registration of the macro information (S510). Subsequent processes are the same as those of Embodiment 7.

In this embodiment, when the macro information is registered into an MFP but and the macro is not executable on the MFP, other MFPs which are executable the macro are searched automatically, and one of the MFPs is determined as the macro registering device and the macro information is registered into such MFP. It is possible to save time and effort for the user to find out an MFP which is executable the macro and register the macro information into the MFP manually.

### Embodiment 9

A process in which MFP2 registers macro information via an external memory unit will be described. The external memory unit may be a removable recording medium. Alternatively, an external memory server may be used instead

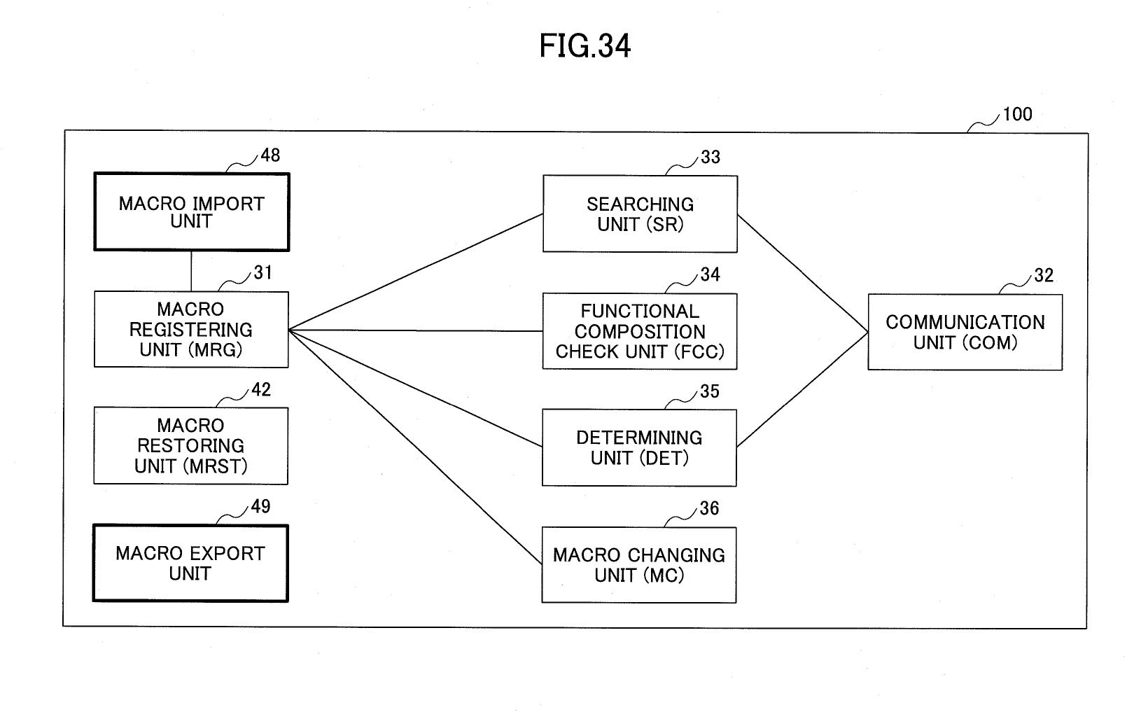

FIG. 34 is a block diagram showing the functional composition of an MFP of this embodiment. In FIG. 34, the elements which are the same as corresponding elements in FIG. 4A are designated by the same reference numerals, and a description thereof will be omitted.

The MFP 100 of this embodiment includes a macro import unit 48 and a macro export unit 49. The macro export unit 49 writes macro data received from a macro registering device (for example, MFP1) in which macro information is registered, to the external memory unit. The macro import unit 48 is used by the macro import device (MFP2) to read the macro information from the external memory unit and transfer the macro information to the macro registering unit (MRG) 31. After the macro registering unit (MRG) 31 receives the macro information, subsequent processes are the same as in the foregoing embodiments.

In this embodiment, the macro registering device (in which macro information is registered) exports the macro information to the external memory unit, and the macro import device can import the macro information from the external memory unit. Extraction and capturing of the macro information can be performed between MFPs which are not connected via the same network.

As described in the foregoing, according to the present disclosure, it is possible to provide an information processing system which is capable of obtaining a processing result desired by a user even when a newly macro installed device does not have a function set in macro information.

The present disclosure is not limited to the specifically disclosed embodiments, and variations and modifications may be made without departing from the scope of the present disclosure.

The present application is based upon and claims the benefit of priority of Japanese patent application No. 2011-037584, filed on Feb. 23, 2011, the contents of which are incorporated herein by reference in their entirety.

What is claimed is:

1. An information processing system including information processing devices connected via a network, each information processing device including a processor to control the information processing device, the processor comprising:
a macro information reading unit configured to read, from a macro information storage unit or a removable recording medium, macro information in which a pertinent device to perform each process of a series of processes is registered as being the information processing device or another information processing device connected via the network;
a device functional composition storage unit which stores device functional composition information of the information processing device;
a functional composition check unit configured to determine permission of the information processing device to execute each process, depending on whether a function included in the macro information and required to execute the process is registered in the device functional composition information;
a searching unit configured to search a second information processing device connected via the network;
an inquiring unit configured to receive an inquiry result response from the second information processing device, indicating whether the second information processing device has a function required to execute the process which function is determined as being not executable on the information processing device by the functional composition check unit; and
a macro changing unit configured to change the pertinent device of the process in the macro information to the second information processing device when the second information processing device has the function required to execute the process and determined as being not executable on the information processing device, and set the pertinent device of the process in the macro information to the information processing device when the function required to execute the process is determined as being executable on the information processing device.

2. The information processing system according to claim 1, wherein the processor further comprises:
a determining unit configured to determine, when the macro information reading unit reads macro information from a macro information storage unit or a removable recording medium of a third information processing device, a function included in the macro information and required to execute a process is not executable on the information processing device, and a pertinent device of the process in the macro information before being changed by the macro changing unit is not set to the third information processing device, that the pertinent device of the process in the macro information is not to be changed.

3. The information processing system according to claim 1, wherein the processor further comprises:
a determining unit configured to determine, when the macro information reading unit reads macro information from a macro information storage unit or a removable recording medium of a third information processing device, a function included in the macro information and required to execute a process is not executable on the information processing device, and a pertinent device of the process in the macro information before being changed by the macro changing unit is set to the third information processing device, that the pertinent device of the process in the macro information is to be changed to the third information processing device.

4. The information processing system according to claim 1, wherein the processor further comprises:
a single device execute permission determining unit configured to determine, when inquiry result responses, received from a plurality of second information processing devices by the inquiring unit, indicate that said devices have a function required to execute the process, the pertinent device of the process in the macro information such that the number of kinds of said devices other than the first information processing device registered in the macro information becomes the smallest.

5. The information processing system according to claim 1, wherein, when inquiry result responses, received from a plurality of second information processing devices by the inquiring unit, indicate that said devices have a function required to execute the process, the macro information changing unit registers the plurality of second information processing devices as the pertinent device of the process in the macro information, and
wherein the processor further comprises:
an associate device determining unit configured to determine, when a plurality of pertinent devices are registered for the process in the macro information, one of the plurality of second information processing devices as an associate device to perform the process based on load information received from each of the plurality of pertinent device.

6. The information processing system according to claim 1, wherein the processor further comprises:
an associate device selection receiving unit configured to display, when inquiry result responses received from a plurality of second information processing devices by the inquiring unit indicate that said devices have a function required to execute the process, a list of the plurality of second information processing devices on a display unit and receive a selection of one of the plurality of second information processing devices.

7. The information processing system according to claim 2, wherein the processor further comprises:
an operation execute permission determining unit configured to determine, when inquiry result information received from a plurality of second information processing devices by the inquiring unit indicate that said devices have a function required to execute the process, whether a hardware unit required to perform a predetermined process in the series of processes is installed therein; and
an operation execute device determining unit configured to receive an inquiry result response from at least one of the plurality of second information processing devices, indicating whether the series of processes are executable thereon by itself or using functions of other associate devices,
wherein the operation execute device determining unit requests the at least one of the plurality of second information processing devices to register the macro information when the inquiry result response indicates that the series of processes are executable.

8. The information processing system according to claim 7, wherein the operation execute device determining unit displays on a display unit a list of two or more second information processing devices the inquiry result responses of which indicate that the series of processes are executable, and receives a selection of one of the two or more second information processing devices input by a user.

9. The information processing system according to claim 7, wherein the operation execute device determining unit determines as a macro registering device one of the plurality of second information processing devices from which inquiry result responses indicating that the series of processes of the macro information are executable thereon are received.

10. The information processing system according to claim 9, wherein each of the plurality of second information processing devices is arranged to output a count number of times of execution of the process in response to a request from another device, and the operation execute device determining unit determines as a macro registering device one of the plurality of second information processing devices corresponding to a largest count number among the count numbers received from the plurality of second information processing devices.

11. The information processing system according to claim 9, wherein the operation execute device determining unit determines, as a macro registering device, one of the plurality of second information processing devices other than the information processing device in which the macro information has been registered, by retrieving identification information, included in the macro information, of the information processing device in which the macro information has been registered.

12. The information processing system according to claim 1, wherein the processor further comprises:
a macro export unit configured to write the macro information to the recording medium; and
a macro import unit configured to read the macro information from the recording medium.

13. An information processing device which is connected to other information processing devices via a network and includes a processor to control the information processing device, the processor comprising:
a macro information reading unit configured to read, from a macro information storage unit or a removable recording medium, macro information in which a pertinent device to perform each process of a series of processes is registered as being the information processing device or another information processing device connected via the network;
a device functional composition information storage unit which stores device functional composition information of the information processing device;
a functional composition check unit configured to determine permission of the information processing device to execute each process, depending on whether a function included in the macro information and required to execute the process is registered in the device functional composition information;
a searching unit configured to search a second information processing device connected via the network;
an inquiring unit configured to receive an inquiry result response from the second information processing device, indicating whether the second information processing device has a function required to execute the process which function is determined as being not executable on the information processing device by the functional composition check unit; and
a macro changing unit configured to change the pertinent device of the process in the macro information to the second information processing device when the second information processing device has the function required to execute the process and determined as being not executable on the information processing device, and set the pertinent device of the process in the macro information to the information processing device when the function required to perform the process is determined as being executable on the information processing device.

14. A non-transitory computer-readable recording medium storing a program which, when executed by a computer, causes the computer to perform a macro control method for an information processing device connected to other information processing devices via a network and including processor to control the information processing device, the method comprising:
reading, by a macro information reading unit of the processor, from a macro information storage unit or a removable recording medium, macro information in which a pertinent device to perform each process of a series of processes is registered as being the information processing device or another information processing device connected via the network;
determining, by a functional composition check unit of the processor, permission of the information processing device to execute each process, depending on whether a function included in the macro information and required to execute the process is registered in device functional composition information stored in the information processing device;
searching, by a searching unit of the processor, a second information processing device connected via the network;
receiving, by an inquiring unit of the processor, an inquiry result response from the second information processing device, indicating whether the second information processing device has a function required to execute the process which function is determined as being not executable on the information processing device; and
changing, by a macro changing unit of the processor, the pertinent device of the process in the macro information to the second information processing device when the second information processing device has the function required to execute the process and determined as being not executable on the information processing device, and setting the pertinent device of the process in the macro information to the information processing device when the function required to perform the process is determined as being executable on the information processing device.
